(19) United States
(12) Patent Application Publication
(10) Pub. No.: US 2017/0142910 A1
(43) Pub. Date: May 25, 2017

(54) Modular Stepped Reflector

(71) Applicant: Surna Inc., Boulder, CO (US)

(72) Inventors: Jordan JOHNSON, Longmont, CO (US); Stephen KEEN, Erie, CO (US); Chris PEARSON, Boulder, CO (US); Todd WHITAKER, Boulder, CO (US)

(73) Assignee: Surna Inc., Boulder, CO (US)

(21) Appl. No.: 15/307,210

(22) PCT Filed: May 1, 2015
(86) PCT No.: PCT/US15/28803

§ 371 Date: Oct. 27, 2016

Related U.S. Application Data
(60) Provisional application No. 61/987,905, filed on May 2, 2014.
(60) Provisional application No. 62/052,890, filed on Sep. 19, 2014.
(60) Provisional application No. 62/078,267, filed on Nov. 11, 2014.

(51) Int. Cl. A01G 7/04; F21V 29/503; F21V 29/505; F21V 29/58; A01G 1/00; F21V 29/83; F21V 29/76; F21V 7/00; F21V 7/08; F21V 17/10; F21V 29/15; F21V 29/67

(52) U.S. Cl. CPC A01G 7/045; F21V 29/15; F21V 29/503; F21V 29/505; F21V 29/58; F21V 29/673; F21V 29/83; F21V 29/763; F21V 7/005; F21V 7/08; F21V 7/0025; F21V 17/104; A01G 1/001; F21Y 2103/00

(57) ABSTRACT

Provided herein are optical reflectors having a plurality of specially designed reflective surfaces and geometrical arrangement to provide improved illumination of a target area. Also provided are related methods for growing plants with the optical reflectors described herein. The reflective surfaces provide substantially normally aligned light over the entire target area, thereby minimizing shading issues of conventional optical reflectors. Also disclosed herein are efficient cooling by air and/or fluid that can substantially reduce cooling requirements by conventional air conditioning with attendant power savings.

### CROSS-REFERENCE TO RELATED APPLICATIONS

This application claims the benefit of and priority to U.S. Provisional Application Nos. 62/078,267 filed Nov. 11, 2014, 62/052,890 filed Sep. 19, 2014 and 61/987,905 filed May 2, 2014, each of which are herein incorporated by reference in their entirety to the extent not inconsistent herewith.

### BACKGROUND OF INVENTION

The invention is generally in the field of optical reflectors that provide improved optical characteristics such as an increased uniformity of light intensity over desired areas. Applications for the optical reflectors provided herein include agriculture where increased efficiency of light application provides the functional benefit of improved growth characteristics including higher plant yields.

Current reflectors that are used for indoor agricultural purposes can have designs that spread the light not only unevenly but also to non-targeted areas, therefore causing waste. Some of those designs use very small reflectors which inherently cause a high angle of incidence on the plant canopy, therefore greatly reducing the intensity of the light reaching the edges of the canopy. As well, conventional reflectors use, almost exclusively, standard sheet metal fabrication techniques to produce the frames and reflective surfaces. This allows for very little precision in terms of reflective surfaces. Due to low precision of specular reflective surfaces and poor manufacturing, “hammered” or “peened” reflective surfaces are used instead in an attempt to achieve a more even light spread. This has the effect of sending a significant amount of light from the bulb in directions that result in high angles of incidence upon the plant canopy, including up to multiple rows away from the source.

As well, conventional reflectors do not allow the same reflector to be used for multiple bulb styles. While the “mogul” base is often attached to high pressure sodium (HPS) or metal halide (MH) bulbs, allowing a reflector to use both types of bulb, no reflectors allow the use of a double-ended HPS while also being able to support a mogul base or any other style of bulb base without major modifications to the reflector.

### SUMMARY OF THE INVENTION

Provided herein are optical reflectors having improved illumination characterstics with respect to a target area where illumination is desired. The improved illumination characteristics refers to the optical reflector that both minimizes direct light loss to regions surrounding the target area and provides better light distribution over the entire target area. For example, the configuration of elements and selected geometry ensures that substantially normal light is provided over substantially the entire target area. In this manner shading is minimized or avoided, which is otherwise an issue for agricultural applications where as plant growth occurs, canopy height increases, and individual plants may shade adjacent plants, particularly for obliquely directed light. In this manner, plant growth is maximized compared to other light systems that do not prevent light wastage or ensure normally-directed light.

Furthermore, any of the reflectors provided herein are designed so as to facilitate cooling, thereby decreasing power requirements by minimizing the air cooling necessary to maintain an environment in which the reflectors are positioned within a desired tolerance. In an aspect where the application is for plant growth, the tolerance may correspond to less than 40° C., less than 35° C., between about 20° C. and 37° C., or at a desired temperature so as to maximize plant growth or yield. In this aspect, the improvement in light characteristics provides savings in terms of efficient use of generated light, which can mean that lower power light sources can provide the same functional outcome as correspondingly higher power light sources, as well as lower cooling demands. This provides a significant benefit in terms of cost savings, particularly for large-scale agricultural applications having a large number of optical light sources.

In an embodiment, the invention is an optical reflector comprising a topwall and a sidewall, and optionally: a central section comprising: a top having a first top side and a second top side; a first side connected to and extending from the first top side; a second side connected to and extending from the second top side, wherein the first side and the second side opposibly face each other to define an interior volume and each of the first and second sides have an interior facing surface at least a portion of which comprises a side reflective surface to reflect light to a target area beneath the optical reflector. A sub-reflector assembly is connected to an interior facing surface of the top and positioned within the interior volume. The sub-reflector assembly is useful for providing desired target area illumination over certain target area regions and to avoid wasted light that is otherwise directed outside the target area or within a target area but in a very oblique direction (e.g., less than about 30°). The sub-reflector assembly may comprise a first and a second longitudinally-extending member arranged in an opposable configuration with respect to each other and longitudinally aligned with the first side and the second side, each longitudinally extending member comprising a reflective surface that opposibly face each other in an inward facing direction. The pair of longitudinally-extending members defines a sub-reflector volume positioned between an optical light source and at least a portion of a target area beneath the optical reflector to direct light generated from an optical light source to the target area.

In an aspect, the light source's relative position to three separate reflective surfaces is selected to achieve the desired illumination characteristics over the entire target area. For example, one portion of the illuminated light reflects off a top reflective surface, another portion is reflected off a side reflective surface, and a third is reflected off the longitudinally extending member reflective surface. The only light to reach the target area that has not interacted with a light reflective surface is the light that is directed downward through the sub-reflector volume. Substantially all other light emitted by a light source encounters a reflective surface, thereby ensuring the desired substantially normal incident light over the entire target area, even for relatively large target areas (e.g., greater than 70 ft²). In an aspect, at least 90% of light emitted from the light source is directed to the target area. In an aspect, about 95% of all light emitted from the light source exits the reflector provided herein, and at least 93% of the emitted light that exits the reflector hits the target area, with the remainder falling outside the target area.

In an embodiment, each of the first and second longitudinally-extending members reflective surface is configured to provide substantially normal incident light over substantially all of the target area and prevent direct light leakage to a non-target area that is outside the target area during use of the optical reflector. In this embodiment, “substantially normal” refers to light that is between 45° and 90° relative to horizontal, including between 55° and 90°, and 60° and 90°. “Substantially all of the target area” refers to at least 90%, at least 95%, at least 99%, or the entire target area.

In an aspect, each of the longitudinally-extending member's reflective surfaces are positioned at an off-vertical angle that is greater than or equal to 5° and less than or equal to 50°, have a width that extends in a direction toward the target area that is greater than or equal to 1″ and less than or equal to 5″, and have reflective surfaces that are curved, including a curvature defined by a plurality of complex elliptical surfaces, wherein the curvature is smoothly varying without sharp edges or points between adjacent complex elliptical surfaces.

The longitudinally-extending members reflective surfaces provide control of light direction along one axis. Similar control may be provide along another axis orthogonal thereto. In this aspect, the optical reflector may further comprise a first end reflective surface connecting the first longitudinally-extending member reflective surface to the second longitudinally-extending member reflective surface at a first end; and a second end reflective surface connecting the first longitudinally-extending member reflective surface to the second longitudinally-extending member reflective surface at a second end. In this manner, the ends and members form four sides of the sub-reflector volume with an open top surface for heat transfer and bulb access and an open bottom surface for light transmission toward a target area beneath the optical reflector.

The sub-reflector assembly is configured to have minimal adverse interference with airflow, thermal dissipation, and bulb handling. Accordingly, the sub-reflector assembly may further comprise: a first end bracket connected to a first edge of the first longitudinally-extending member and a first edge of the second longitudinally extending member; and a second bracket connected to a second edge of the first longitudinally-extending member and a second edge of the second longitudinally extending member.

The sub-reflector assembly may further comprise a mounting bracket that operably connects the sub-reflector assembly to the top interior facing surface, such as a first mounting bracket connected to the first end bracket and a second mounting bracket connected to the second end bracket. The mounting bracket may be moveably connected to the top central section. The moveable connection may comprise a tongue and groove connection to provide a slideable connection between the sub-reflector assembly and top central section.

The groove may be positioned in or on an interior facing surface of the top central section and the tongue extends from a top surface of the mounting bracket.

The sub-reflector volume has an open top surface defined between a top edge of the first longitudinally-extending member and a top edge of the second longitudinally-extending member.

In an aspect, the first and second longitudinally-extending members are substantially rectangular shaped and having a longitudinal length and each of the first and second sides have a side longitudinal length, wherein the longitudinally extending member longitudinal length is less than the side longitudinal length. In an aspect, provided is a ratio of longitudinal length to side longitudinal length that is less than 0.5. For example, the bulb may be about 12″ in length, and the side length about 30″. This can be particularly beneficial in that the location of the light source within the optical reflector may be laterally positioned with respect to the side depending on desired target area illumination. For example, at an end of a row, the light source may be positioned at, or close to, an an end of the optical reflector interior volume so that light from the reflector is matched to the position of the end of the plant row, thereby minimizing wasted light at the end of the row. Alternatively, a plurality of bulbs each with a unique and positionable sub-reflector assembly may be positioned in a single optical reflector. Accordingly, any of the optical reflectors provided herein may comprise a plurality of sub-reflector assemblies for receiving a plurality of optical light sources or a light source that is off-centered relative to the center of the interior volume.

Any of the optical light sources may connect to the optical reflector at a non-reflective surface, thereby further improving light output hitting the target area.

In an embodiment, any of the reflective surfaces may comprise polished aluminum. The reflective surface may itself correspond to an element provided herein, such as a longitudinally extending member that is itself the reflective surface, in a unitary configuration. Alternatively, the element may support a separate reflective surface, such as a side or top having a separately defined liner that is the reflective surface. In an aspect only one side is a reflective surface. In an aspect, both sides comprise reflective surfaces, although one surface may be more highly reflective than another surface, including a more highly reflective surface corresponding to the surface on which the primary light rays hit.

Any of the optical reflectors provided herein may further comprise a top reflective surface positioned between the top central section and the pair of longitudinally-extending members for reflecting light from a direction that is toward the top central section to a target area beneath the optical reflector. In an aspect, the top reflective surface reflects light toward an outer region of a target area, such as an outer region that is between about 10% and 20% of the width of the target area. In particular, this aspect provides an important functional benefit of more normally directed light that interacts with plants on the outer region of the target area. In conventional systems, by contrast, these outer regions typically are more shaded by obliquely-directed light (e.g., less than 45° from horizontal) that is shaded by tall plants positioned in the middle of the target area. This is a fundamental improvement that is important for ensuring all positions of the plant, including outer-most positions, are exposed to more uniformly normal light and corresponding light intensity. This provides improved growth characteristics and higher plant yield.

Any of the reflective surfaces provided herein, including the side reflective surface and/or top reflective surface, comprises a replaceable liner, such as a polished aluminum liner or specular aluminum. This aspect is particularly beneficial as reflective surfaces may degrade over time, reducing lighting efficiency or desirable lighting characteristics. To maintain high quality reflective surfaces, the liners may be configured to slideably engage with or mount to a corresponding mounting surface, including the inner facing surfaces to the top and side central sections.

Any of the optical reflectors provided herein may further comprise an optically transparent material that connects a bottom edge of the first side to a bottom edge of the second side. In this aspect, the enclosure volume is more fully enclosed with a bottom surface through which light can pass to illuminate a target area. In an aspect, the optically transparent material comprises a low iron glass and/or an anti-reflective coating. In an aspect, the optically transparent material transmits from the internal volume to the target area at least 85% of electromagnetic radiation in the visible spectrum generated from an optical source in the enclosure volume during use. The geometry of the mirrors and relative positions then ensure that at least 90%, or at least 93% of all light emitted from the internal volume is directed to a target area, with a relatively uniform distribution and high level of normalcy (e.g., all light within about 40° or within 37° of vertical).

Any of the optical reflectors provided herein may further comprise a light source. The light source may be any commercially-available light source having desired operating and optical characteristics as determined by the end application. For agricultural growing operations, the light source is selected to generate maximum light at wavelengths used in photosynthesis of the plant being grown in the target area. In an aspect, the light source is selected from the group consisting of incandescent, fluorescent, high intensity discharge (HID) including metal halide, high-pressure sodium or mercury vapor, one or a plurality of LEDs, or the like. In an aspect, the light source is a longitudinally aligned light source that has a longitudinal axis aligned with a longitudinal axis of the optical reflector. Any of the various light sources are connected, directly or indirectly, to a top central section of the optical reflector. A tube that is thermally insulative and optically transparent may be used to thermally isolate the longitudinally aligned light source, wherein the longitudinally aligned light source is concentrically positioned relative to the tube. “Concentrically positioned” refers to a configuration so that no outer surface of the light source directly physically contacts an inner surface of the tube. In an aspect, the tube comprises quartz.

In an aspect, the light source and tube further comprise a first and second end spacer to physically separate the longitudinally aligned light source from the tube by a separation distance, wherein the separation distance is selected from a range that is greater than or equal to 1 mm and less than or equal to 10 cm to form an insulated optical volume. This configuration is useful for maintaining a bulb operating temperature within a desired range. A challenge in the art arises from cooling of the optical reflectors to avoid overheating of the environment without adversely affecting output light because output spectrum changes with changes in bulb temperature. By incorporating the specially configured bulb-tube into the instant optical reflectors, this challenge is addressed. Accordingly, any of the optical reflectors provided herein may further comprise a source of cooled air that flows over an outer surface of the tube, wherein the insulated optical volume is maintained within 20% of a desired operating temperature during use of the longitudinally aligned light source and the interior volume surrounding the tube has an average temperature that is less than or equal to about 70° C.

In an embodiment, provided herein is a longitudinally aligned light source surrounded by a quartz tube, such as a light source that is a high-pressure sodium light source.

Any of the optical reflectors provided herein may further comprise a first and a second hanger assembly, wherein each of the hanger assemblies is connected to an outer-facing surface of the top central section and separated from each other by a hanger separation distance. Each hanger assembly may be moveably connected to the top outer-facing surface. This provides increased versatility for mounting the reflector to a ceiling or a mount connected thereto.

The hanger assembly may further comprise a curved hanger bracket having a central portion with a first end and a second end extending therefrom. Each of the first end and second end extend in a downward direction relative to the central portion and terminate in a mounting end that connects to the top; and a fastener connected to a top surface of the hanger for suspending the optical reflector from an external surface or mount. In this manner, the optical reflector may be positioned in a desired location, and the hanger assemblies moved to a desired mount location to reliably secure the optical reflector. The moveable connection may comprise a pair of slideable tongue and groove connections, wherein the tongue is at each of said first and second end of the curved hanger bracket, and the grooves are supported by or embedded in an outward facing surface of the top and configured to slideably receive the tongues.

Any of the optical reflectors provided herein may further comprise end plates that define ends of the interior volume. In an embodiment, the optical reflector further comprises a first end plate connected to a first edge of the top, first side and second side. A second end plate may correspondingly connect to a second edge of the top, first side and second side. Optionally, each of the first and second end plates have an inner facing surface that is a reflective surface.

In an aspect, any of the reflective surfaces may have a curvature defined by a plurality of complex elliptical shapes. For example, each of said side reflective surfaces and/or longitudinally-extending member reflective surfaces have a curvature defined by a plurality of complex elliptical shapes. The complex ellipses can have two or more sections of an ellipse. In this manner, the curved reflective surfaces may have a continuously and smoothly varying curvature. The curvature having multiple complex elliptical shapes may be smoothly transitioning such that there are no sharp edges when transitioning between adjacent curvatures. In an aspect, the plurality of complex elliptical shape side reflective surfaces are selected from a number that is greater than or equal to 3 and less than or equal to 50; and the plurality of complex elliptical shape longitudinally-extending member reflective surfaces are selected from a number that is greater than or equal to 3 and less than or equal to 15. Such a plurality of individual complex elliptical shapes that form a curved reflective surface allows for precise optical matching between sub-regions of a reflective surface and a sub-region of a target area along with substantially normal angles of incidence light on the target area. Accordingly, any of the reflective surfaces provided herein may be defined in terms of a plurality of complex elliptical shapes, with each complex elliptical shape optically aligned with a sub-region of the target area. In an embodiment, each individual of the plurality of complex elliptical shapes are optically aligned with an individual sub-region of the target area. In this aspect, “optically aligned” refers to light reflected from a provided individual complex elliptical shaped portion of the reflector to a user-defined sub-region of the target area in a substantially normal direction relative to the plane defined by the target area. Similarly, entire reflective surfaces may be optically aligned with respect to a sub-region of the target area, thereby ensuring good light distribution, and minimization of hot spots or dead zones.

In an embodiment, any of the optical reflectors provided herein are actively air-cooled optical reflectors. “Actively air-cooled” refers to air that is actively flowed into the internal volume for thermal cooling with heated air removed from the internal volume, such as by convection or forced air movement, including by a fan or pump.

In this embodiment, the optical reflector may further comprise a first end plate connected to a first edge of the top, a first edge of the first side and a first edge of the second side. The first end plate has an inlet duct or opening for introducing a flow of air to the interior volume. A corresponding second end plate is connected to a second edge of the top, a second edge of the first side and a second edge of the second side. The second end plate has an outlet duct or opening to remove a flow of air from the interior volume. To provide a more air-tight interior volume, in this aspect the optical reflector may have a transparent material to define a bottom surface of the interior volume, with the transparent material connected to the sides and end plates in a square or rectangular shape.

The optical reflector may further comprise an air filter fluidically connected to the inlet duct, thereby ensuring only filtered air is introduced to the internal volume, thereby minimizing dirt and contaminant introduction that could adversely affect light efficiency and operation. The air filter may be removable to facilitate cleaning or replacement.

In the air-cooled embodiment, preferably a longitudinally aligned light source is connected to the top central section and a tube that is thermally insulative and optically transparent provides thermal isolation of the longitudinally aligned light source, including during forced-air cooling by air introduced to the internal volume. In this embodiment, the longitudinally aligned light source may be substantially concentrically positioned relative to the tube. In this aspect, “substantially concentrically positioned” refers to a light source that does not directly contact an inner surface of the tube, thereby enhancing thermal insulation of the light source, with airflow over the outer-facing surface of the tube.

The substantially concentrically positioned aspect provides a well-defined insulated optical volume between an outer surface of the longitudinally aligned light source and an inner surface of the tube; wherein flow of air introduced at said inlet duct is directed over an outer surface of the tube to provide thermal cooling of the optical reflector interior volume without substantially changing temperature in the insulated optical volume. In this manner, a desired operating temperature of the bulb can be maintained, even for relatively high air flow rates over the light source/tube configuration. This provides an important functional benefit of maintaining or improving light generation characteristics over a wide range of operating conditions and air cooling flow-rates, wherein unwanted heat outside the tube is dissipated without substantially changing or affecting desired bulb operating temperature. In contrast, cooling of the optical reflector with the insulative tube can change the bulb operate temperature, thereby reducing spectral output.

In an aspect, the inlet duct introduces a flow of air at an air flow-rate that is greater than or equal to 100 cubic feet/minute and less than 10,000 cubic feet/minute, or between 100 and 1,600 cubic feet/minute.

The optical reflectors provided herein are optionally further characterized in terms of operating temperatures, such as by an inlet air temperature at the inlet duct and an outlet air temperature at the outlet duct, wherein the outlet air temperature is hotter than the inlet air temperature by a temperature that is equal to or between 0.1 to 10° C. This provides a measure of the thermal cooling capacity of the system and is useful in exemplifying potential decrease in cooling costs by conventional electrically powered air conditioning systems.

In an embodiment, any of the optical reflectors provided herein are cooled by a heat exchanger assembly in thermal contact with the optical reflector. In an aspect, the heat exchanger assembly is an air-to-fluid or air-to-water heat exchanger. In this embodiment, the terms “water” and “fluid” may be used interchangeably and reflects that water is a convenient, cheap, and easily handled fluid to provide cooling. The invention provided herein is, of course, compatible with other fluids having a desired thermal transfer property. For example, in cases where fluid freezing is a concern, the water may be supplemented with an anti-freeze chemical to decrease freezing temperature of the fluid. In an aspect, the water introduced to the heat exchanger for cooling may be from a water tower positioned outside the room in which the optical reflector is located.

In an aspect, the heat exchanger assembly is thermally connected to the top central section. The configuration of the sides and top of the central section may also facilitate physical contact between the heat exchanger assembly and the top and/or sides of the optical reflector central section.

In an embodiment, the heat exchanger assembly comprises an air-to-water heat exchanger having: a water inlet port for the introduction of cool water to the air-to-water heat exchanger; a water outlet port for removing heated water from the air-to-water heat exchanger; a thermal exchange portion that fluidically connects the water inlet port and the water outlet port configured to cool a flow of air across the thermal exchange portion; and an air port fluidically connecting the heat exchanger assembly with the interior volume, wherein air introduced from said interior volume via holes in a non-illuminated portion of the center side, such as the upward angled interior region, is cooled by said air-to-water heat exchanger. In an embodiment, the air introduced is from said interior volume via holes in a non-illuminated portion of a surface of the interior volume. Alternatively, a single fan is employed to achieve the desired cooling.

In an aspect, the optical reflector further comprises a fan for forcing airflow across or over the thermal exchange portion. For example, two fans may be positioned on top of the air-to-water heat exchanger for drawing air from the interior volume and through the air-to-water heat exchanger, to cool the hot air from the interior volume.

The cooled air may then be introduced to a surrounding environment in which the optical reflector is located to provide thermal cooling of the surrounding environment. Alternatively the cooled air may be reintroduced to the interior volume to cool the optical reflector. Alternatively, the cooled air may be used in another part of an environmental control system of which the optical reflector is a component. In an aspect, the surrounding environment is a room in which plants are growing.

In an embodiment, the optical reflector further comprises: a first end plate connected to a first edge of the top, a first edge of the first side and a first edge of the second side, the first end plate having an air passage for introducing a flow of air to the interior volume; and a second end plate connected to a second edge of the top, a second edge of the first side and a second edge of the second side, the second end plate having an air passage for introducing a flow of air to said interior volume. Air introduced through the air passages to the interior volume is forced over the air-to-water heat exchanger.

The heat exchanger assembly may further comprise a manifold for supporting the air-to-water heat exchanger. The manifold may comprise a manifold lid and a manifold pan having a concave shaped surface for collecting water condensate or drips and a plurality of manifold passages for receiving a flow of air from the interior volume. In this manner, concern with unwanted moisture interacting with the light source is avoided.

The manifold may be connected to the top central section, the optical reflector further comprising a plurality of passages through the top central section spatially aligned with the plurality of manifold passages.

Any of the optical reflectors provided herein may further comprise a plurality of thermal vents extending through the first side, the second side, and/or the top, for passive movement of air between the interior volume and a surrounding environment. In this embodiment, the bottom surface of the interior volume may be left open to the surrounding environment to facilitate passive air motion into and out of the interior volume.

In another embodiment, the invention is a method of growing a plant using any of the optical reflectors provided herein. For example, the method may comprise the steps of: positioning an optical reflector of any of the optical reflectors described herein in a room; providing a plant or plants in a target area that is located beneath the optical reflector; powering an optical light source operably connected to the optical reflector; and illuminating the plant or plants in the target area with the optical light source, thereby growing the plant.

The method and devices provided herein are compatible with a range of target area sizes and shapes. In an aspect the target area is positioned at a separation distance from the optical light source, wherein said separation distance is greater than or equal to 6″ and less than or equal to 10 feet, or between about 6″ and 8 feet. In an aspect, the target area is greater than or equal to 4 ft² and less than or equal to 75 ft². In an aspect, the target area is defined by the plant canopy. By serially arranging a plurality of the optical reflectors, the target area may be extended in a row-like configuration, with plants growing in the rows. The optical reflectors may then be arranged in a parallel configuration to facilitate plant growth in a plurality of rows. The advantages of the reflectors provided herein is the highly focused illumination on the target area only, with substantially no light directly wasted on non-target areas, and the unique high quality substantially normal light over the entire target area providing good grow-light characteristics over the entire target area. These factors correspond to increased growth rate per unit of energy use and per foot of target area.

These functional benefits of the methods and devices may be described quantitatively. For example, illumination quality may be expressed as a substantially normal angle of light incidence provided over substantially the entire target area, such as light having a maximum angle of incidence relative to vertical that is less than 40° (e.g., greater than 50° relative to horizontal). Light intensity over the entire target area may be described as substantially uniform, such as having a maximum variation in intensity that is less than a user-defined value over at least 90% of the target area, including for a plurality of optical reflectors aligned in rows. Another definition of light quality is described in terms of light output from the illuminating step lost to a non-target area that is outside the target area, such as less than 5%, wherein the target area corresponds to the plant canopy footprint, with the target area having any one or more of the desired optical properties described herein. Any of the optical reflectors provided herein may be described in terms of a maximum light intensity that is less than about 2.5 times the lowest light intensity in the target area over 90% of the target area when arranged in rows. Any of the optical reflectors provided herein may be described in terms of an average intensity over 90% of the target area that is less than about 2 times the lowest intensity in the target area.

Any of the methods provided herein may further comprise the step of cooling the optical reflector or environment surrounding the optical reflector, such as by one or more of air cooling or liquid cooling. In an aspect, the cooling may be described as at least 50% more energy efficient than power requirements for a corresponding conventional grow environment.

Any of the optical reflectors may be described as having an outer surface cross-sectional shape that is: a substantially planar top surface; an upward angled interior region connected to an outside edge of the substantially planar top surface; and a downward angled outer portion connected to and extending downwardly from the upward angled interior region.

Any of the reflective surfaces described herein may comprise specular aluminum. Any of the reflective surfaces are at least 95% efficient, wherein less than 5% of incident light is absorbed.

In another embodiment, the optical reflector is described in terms of the specially arranged and configured reflective surfaces that provide improved lighting characterstics to a corresponding target area. In this embodiment, for example, the optical reflector comprises: a top comprising a top reflective surface; a first side connected to the top, the first side having a first side reflective surface; a second side connected to the top, the second side having a second side reflective surface, wherein the top, first side and second side form an interior volume in which an optical light source may be positioned. A sub-reflector assembly is connected to the top and positioned in the interior volume, the sub-reflector assembly comprising a pair of aligned sub-reflector reflective surfaces to form a sub-reflector volume through which downward-directed light from an optical source traverses to a target area beneath the optical reflector. Each of the reflective surfaces are configured to provide a substantially normal direction of light illumination over substantially the entire target area positioned beneath the optical reflector and to prevent illumination of a non-target area that is outside the target area.

In an aspect the top reflective surface provides substantially normal illumination to an outer region of the target area; the side reflective surfaces provide substantially normal illumination to a middle region of the target area; and the pair of aligned sub-reflector reflective surfaces provides substantially normal illumination to an inner region of the target area. The middle region and the inner region may be at least partially overlapping. The outer region may be distinctly defined by light that has only been reflected to the top reflective surface.

In another embodiment, provided herein are optical reflectors for any type of light source that may be used in the agricultural industry. In an aspect, the light is a conventional light bulb. The reflectors include an array of curved reflective surfaces that, when used in series with respect to each other, provide a very uniform spread of light on the targeted area. In an aspect, the targeted area comprises long rows, such as corresponding to rows of plants. In an aspect, the reflectors herein ensure light is directed at a low angle of incidence, such as at a substantially normal direction relative to ground level to minimize shading that is common with more obliquely directed light. In an aspect, the reflector has a modular design that facilitates compatibility with of any kind of bulb and socket combination, including multiple bulbs.

The reflectors disclosed herein provide an improved uniform light distribution over a desired target area, with minimal light distribution outside the desired target area, compared to conventional reflectors. This functional improvement is achieved, at least in part, by incorporation of three distinct light reflecting surfaces, including a first reflective surface, a second reflective surface, and a third reflective surface. In this manner, an optical source positioned in a central region of the reflector emits light that interacts with the three reflective surfaces in such a manner that light exiting the reflector is highly vertical with respect to a target area over which illumination is desired.

In an embodiment, the invention is any of the optical reflectors shown and described herein. In an embodiment, the optical reflector comprises a first reflective surface having an internal volume; a bulb support positioned at least partially in the internal volume; a second reflective surface positioned between a top portion of the optical reflector and a bulb positioned in the bulb support; a third reflective surface connected to the bulb support and extending in a direction toward a target surface area where illumination is desired; wherein each of the reflective surfaces are shaped to maximize light distribution uniformity to the target surface area and minimize an angle of light incidence to the target surface area. Optionally, the optical reflector further comprises cooling fins connected to the bulb support.

Optionally, the bulb support is movably connected to the rest of the reflector so as to provide translational positioning. In an aspect, the reflector surfaces are compound ellipse shapes so as to provide desired light output characteristics. As desired, the particular shapes of the reflector surfaces, sizes, and orientations are selected to achieve a desired light output, such as over a target area that tends to be rectangular and correspond to row of plants. The target area may have a width that is about 2 feet, 3 feet, 4 feet, 5 feet, or any sub-range thereof. Non-target areas may correspond to an access path between adjacent rows of plants. The desired light output characteristics may be quantitatively described in terms of angle of incidence (with 0° corresponding to desired vertical) and a minimum amount of light falling outside a desired target area.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1. Side view of a reflector with cooling fins.

FIG. 2. Close up view of the reflector of FIG. 1.

FIG. 3. Perspective view of the reflector of FIGS. 1-2.

FIG. 4. Side view of a reflector having a different geometry than the reflector of FIGS. 1-3. An optional duct flange for connection to air ducts for cooling is illustrated.

FIG. 5. Perspective view of the reflector of FIG. 4.

FIG. 6. Perspective view of an air-cooled optical reflector.

FIG. 7. Perspective view of the air-cooled optical reflector of FIG. 6, with sub-reflector assembly, end plates and hanger assemblies removed from the central portion.

FIG. 8. Components of an end plate with an inlet duct and an air filter.

FIG. 9. Parts of a central section, with replaceable reflective surface liners, a transparent material, a top and two sides. The parts are separated from each other for clarity.

FIG. 10. Perspective view of a subreflector (left schematic) and a hanger (right schematic) assembly.

FIG. 11. Side view of a central section side, illustrating geometrical curvature.

FIG. 12. Side view of a central section top.

FIG. 13. Perspective view of a mounting bracket.

FIG. 14. Perspective view of a hanging assembly.

FIG. 15. Perspective view of a water-cooled optical reflector.

FIG. 16. Perspective view of a water-cooled optical reflector with subreflector assembly, end plates, heat exchanger assembly, sub-reflector assembly and hanger assembly shown separated from the central section, for clarity.

FIG. 17. Various parts of a heat exchanger assembly.

FIG. 18. Schematic of side view of light paths after reflection from different light reflective surfaces: side reflective surface; top reflective surface; and sub-reflector surface onto a target area. For simplicity, only one-half of the reflective surfaces are shown.

FIG. 19. Schematic top view illustration of the target area of FIG. 18 and corresponding target regions and non-target region. The invention accommodates overlap between different regions. In this embodiment, the inner region and middle region have at least partial overlap.

FIG. 20. Contour plot of light intensity illustrating the light intensity distribution within a 4 ft square target area for the embodiment having reflectors to each side of the optical reflector. The x-axis runs from 0.0 to 6.3 in increments of 0.7 and the y-axis from 0.1 to 19.0 in increments of 2.1 (also FIGS. 21-23).

FIG. 21. Contour plot of light intensity illustrating the light intensity distribution within a 4 ft square target area for a single reflector above the target area.

FIG. 22. Shaded plot of the multiple reflector embodiment of FIG. 20.

FIG. 23. Shaded plot of the single reflector embodiment of FIG. 21.

FIG. 24. Light ray tracing simulation from each of three light-reflecting surfaces: top, side and sub-reflector reflective surfaces, and corresponding distribution over a target area. For clarity, only one-half of the reflective surfaces are illustrated, with the other half that would be a mirror image thereof. Similarly, light rays in a directly-downward direction that do not interact with a light reflecting surface are not shown.

FIG. 25. Light ray tracing simulation from a top reflective surface.

FIG. 26. Light ray tracing simulation from a side reflective surface.

FIG. 27 illustrates an optical reflector housing, or central portion with a top portion and sides.

FIG. 28 illustrates a liquid-cooled optical reflector with one-fan for forcing air flow over a heat exchange assembly.

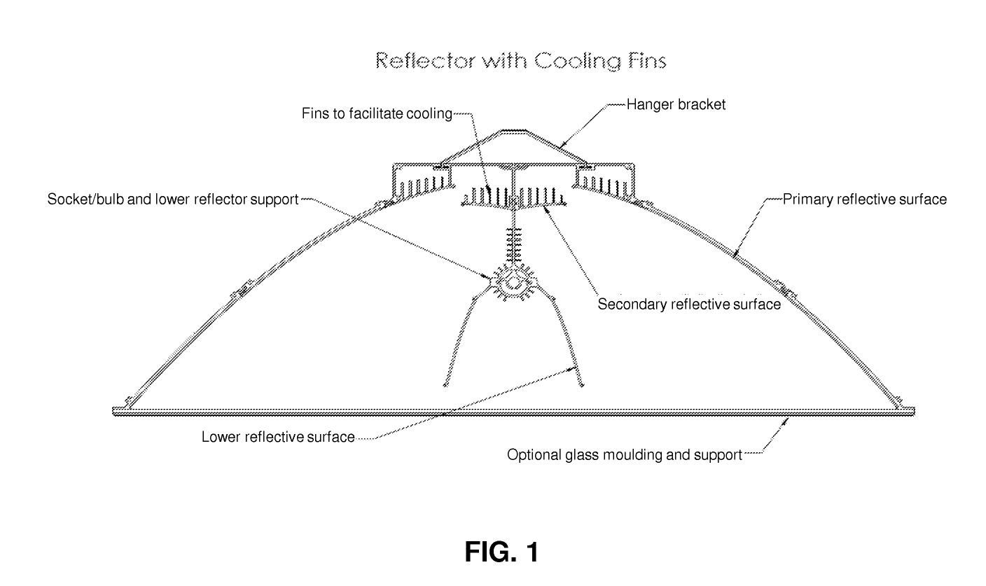

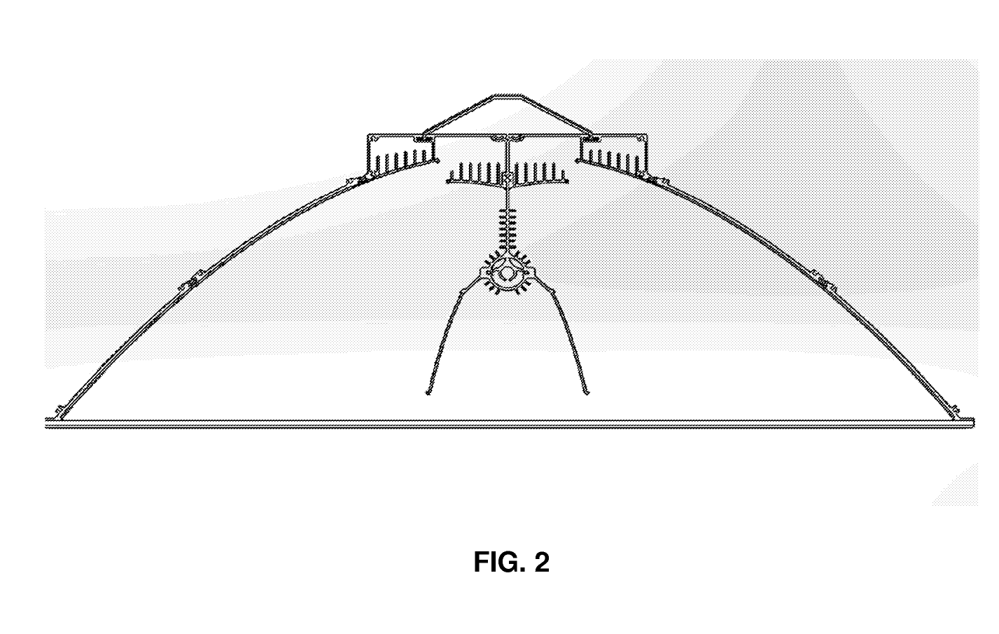

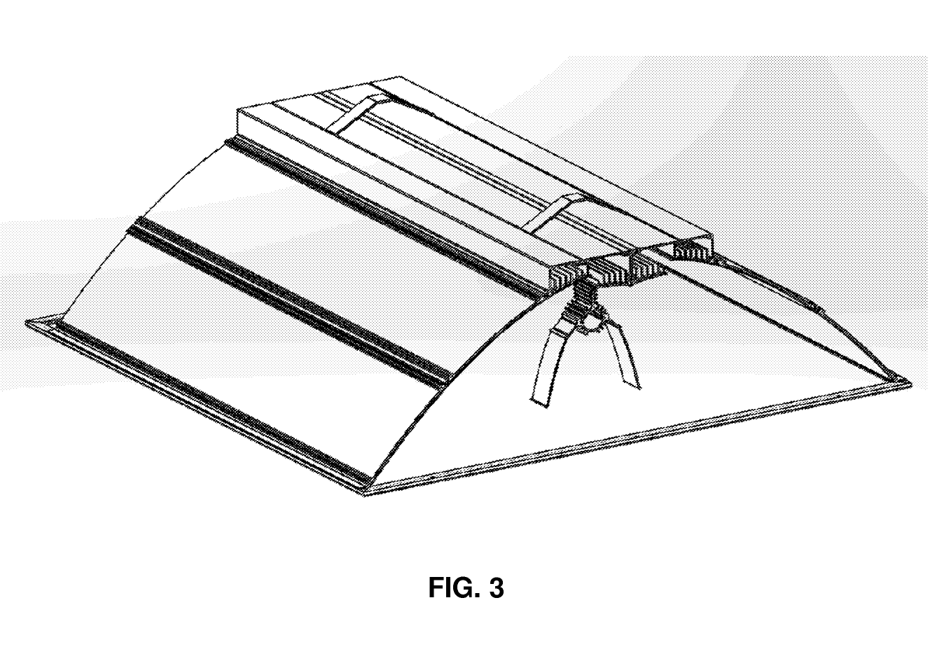

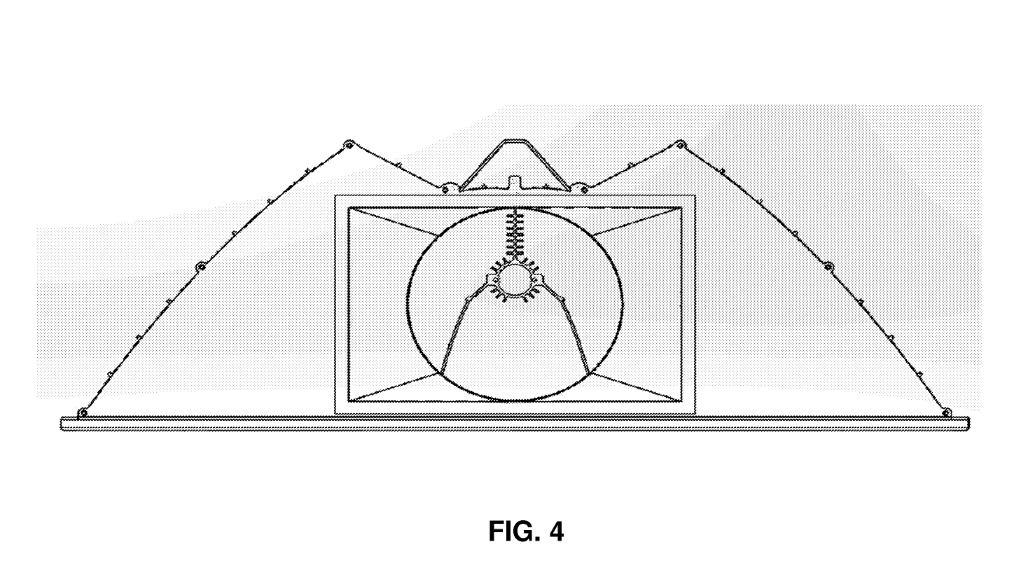

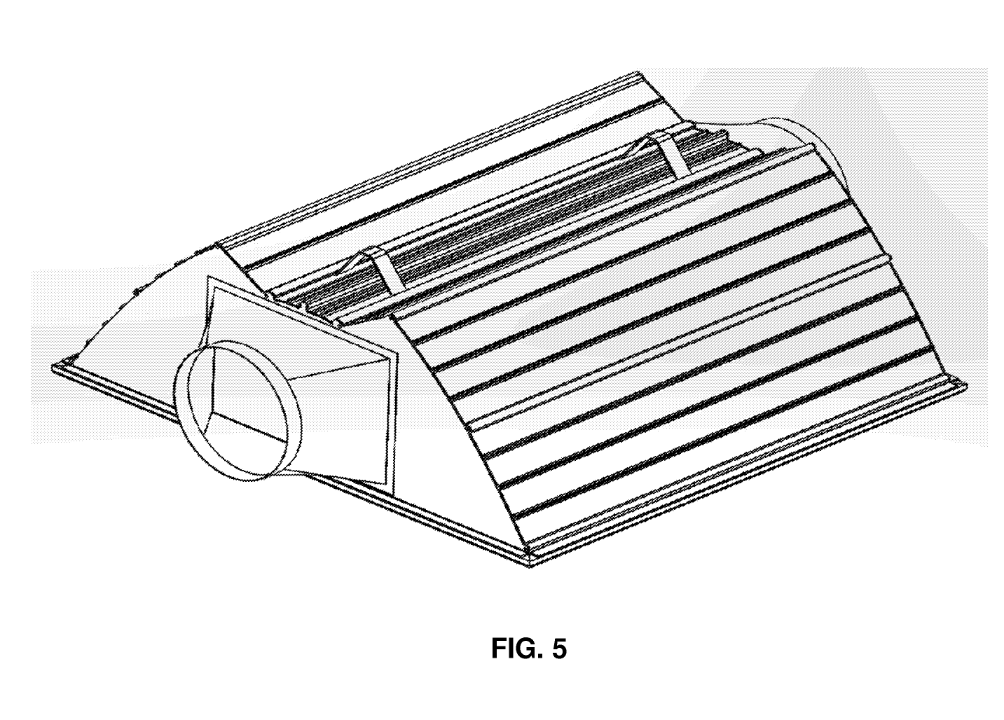

### DETAILED DESCRIPTION OF THE INVENTION

In general, the terms and phrases used herein have their art-recognized meaning, which can be found by reference to standard texts, journal references and contexts known to those skilled in the art. The following definitions are provided to clarify their specific use in the context of the invention.

For applications like indoor agriculture, where plants are grown in rows, the reflectors provided herein can provide direct light that has near vertical rays to only the rows of plants and not to unwanted regions, such as the aisles in between where it would otherwise be wasted. The near vertical rays of light prevents shadowing in areas of uneven plant canopy, therefore providing a light source that has rays most similar to the sun when it is highest in the sky. These lower angles of incidence provide more intense light on the plant canopy than those of higher angles of incidence. There is also a secondary (second) reflector that sits below the center point of the bulb, near the inside of the assembly, that serves to greatly reduce the amount of light that would otherwise be at a higher angle of incidence or be wasted as it hit the aisles of the row in question.

With a higher percentage of the light leaving the bulb actually hitting the plant canopy, higher yields can be realized or lower power bulbs can used to achieve the same yield, thereby minimizing energy requirements. This increase in light quality characteristics can be expressed relative to a target area. As used herein, “target area” is better defined and confined compared to the associated target area for conventional reflectors. For example, the target area may substantially correspond to the shape and area of the bottom edges of any of the optical reflectors described herein, including having a target area magnitude that substantially corresponds to the bottom surface of the enclosure volume of the optical reflector from which light exits. In this aspect, “substantially corresponds” may refer to a target area that is equal to the surface area of the bottom surface of the optical reflector, or that exceeds the surface area of the bottom surface by an amount that is less than 30%, less than 20%, less than 10% or less than 5%. Of course, due to the properties of light, as the separation distance between the optical reflector and target area increases, area that is illuminated tends to increase. The advantages provided herein, however, ensures any of the desired optical properties are achieved within a well-defined target area of the present invention, even for increasing separation distance.

Computer simulations indicate that conventional lights and reflectors achieve about 60-80% of light emitted from the bulb hitting the canopy (e.g., target surface area). Provided herein are reflectors that significantly increase the percentage of light emitted from the bulb hitting the canopy (target surface area), such as greater than 80%, greater than 80% and less than about 93%, between 85% and about 93%, and greater than about 90%. In an aspect, the light hitting the target surface area is described as having a low angle of incidence, such as a near vertical angle ray trace, also referred to herein as “substantially normal”.

Optionally, any of the reflectors further comprise cooling fins on any part that encompasses the frame of the assembly. This draws heat away from the bulb towards the top of the reflector in order to reduce the heat that may be directed at the plant canopy, therefore, reducing the temperature of the plant canopy. This allows for easier thermal management of the room.

Optionally, any of the reflectors have glass or no glass. Advantages of using glass with the reflector include providing that the bulb may be “air cooled” by passing air through the reflector with ducting. The end plate can be modified to include a duct flange for this purpose.

The bracket that supports the bulb as well as the lower reflective surface fits into a slot between the second reflective surfaces which allows it to slide back and forth within the reflector frame. This allows for the use of any style of bulb, of many different sizes, and even the use of two or more bulbs within the same reflector. By simply changing the position of the bracket within the reflector and bolting/wiring in a new socket to the bracket support, a new bulb style can be used without changing any of the reflective properties of the reflector.

The method of manufacture is also not limited to standard sheet metal fabrication using sheers and press brakes. By using aluminum extrusions, hydraulic sheet metal presses, die casting, sand casting, composites forming, vacuum forming, CNC machining, vacuum deposition, etc., many additional features can be added that will improve stiffness of the frame as well as precision of the reflective surface. Parts may be manufactured from any material, such as, but not limited to, any alloy associated with steel, aluminum, titanium, or silver. Also including, but not limited to, glass fiber, basalt fiber, carbon fiber, Kevlar, graphene, carbon nanotubes, plastics, other composites, etc. The use of any high tech material or manufacturing process will only aid in the final performance of the reflector.

### EXAMPLE 1

### Optical Reflector

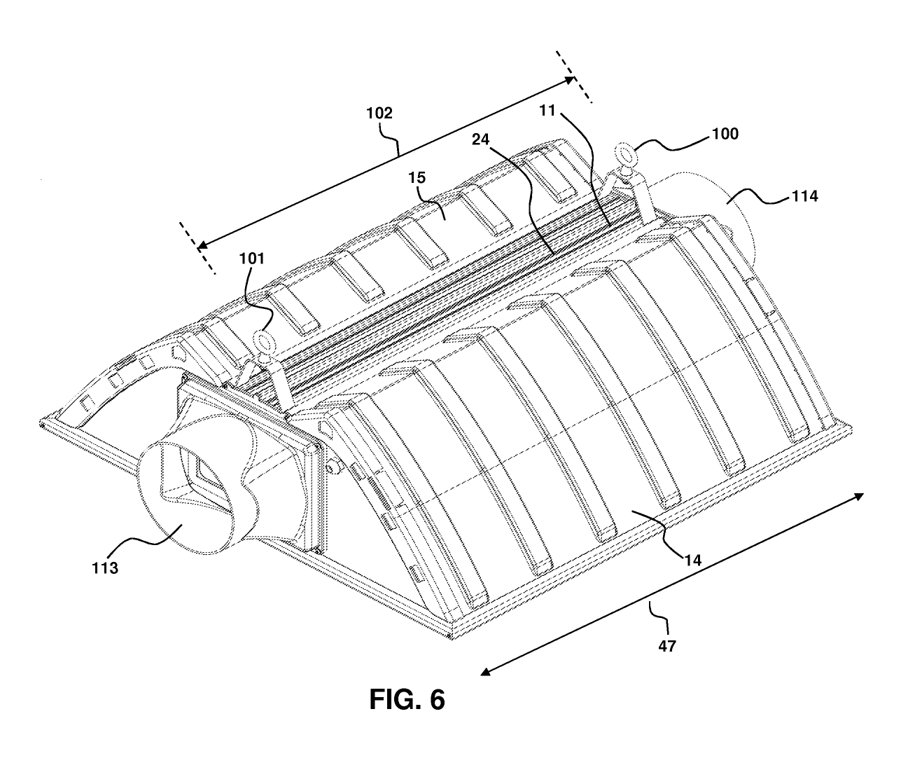

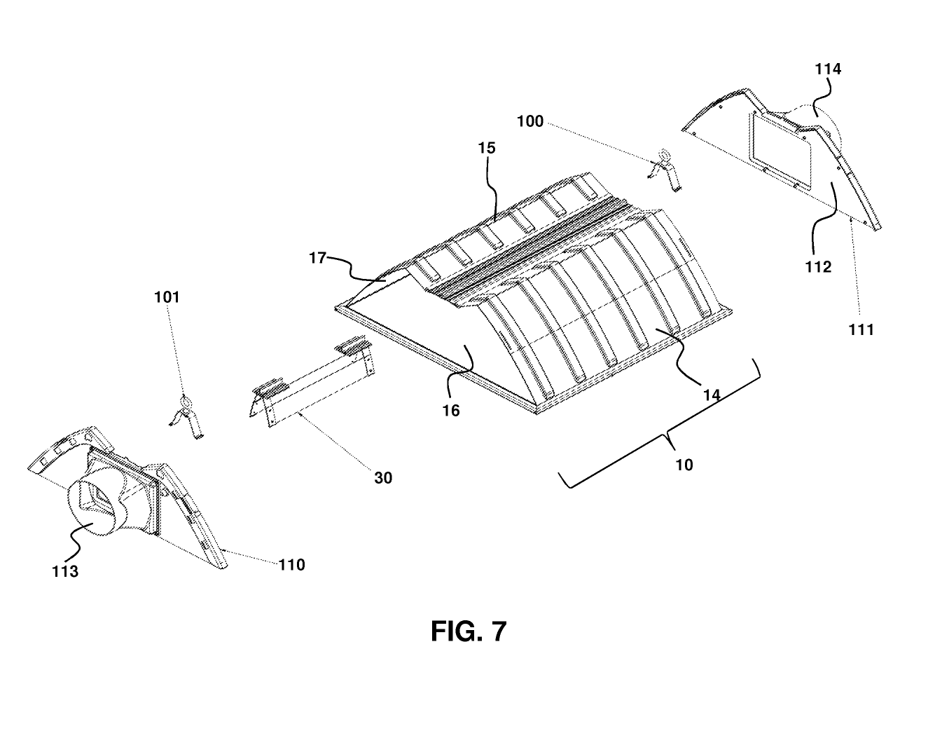

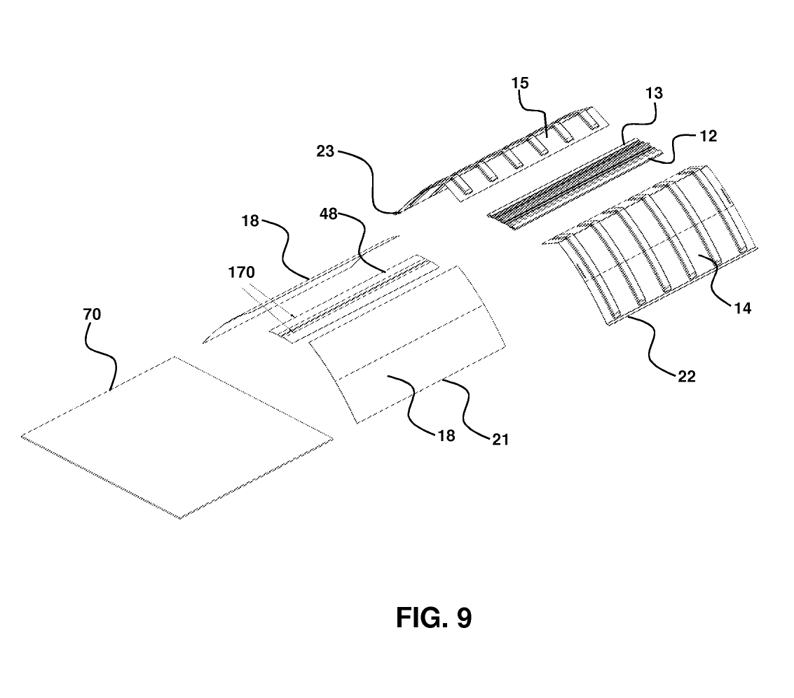

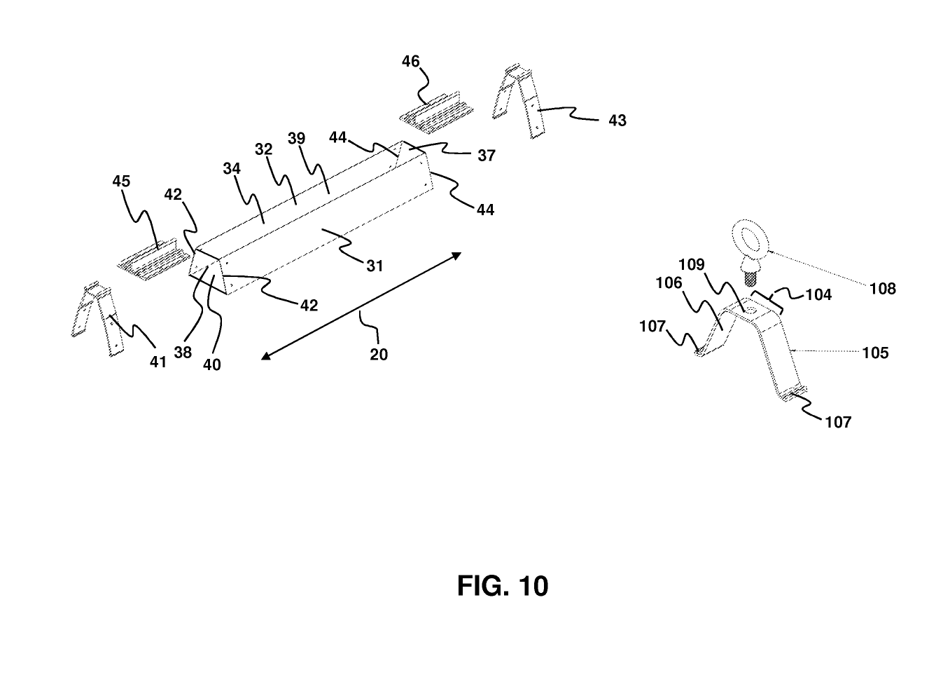

The optical reflector in a basic form comprises a central section 10 having a top (or topwall) 11, a first side 14, and a second side 15 that opposibly face each other creating an interior volume 16. The first 14 and second 15 sides are referred herein as a sidewall of the central section. A sub-reflector assembly 30 is connected to the top interior facing surface 19. FIGS. 6, 7, 12. The sides 14 and 15 are connected to the top 11 by a first top side 12 and a second top side 13, and each side has an interior facing surface 17 at least a portion of which is a side reflective surface 18. FIGS. 9,11. The reflective surfaces may comprise replaceable liners 21 (FIG. 9). The top reflective surface may actually comprise two distinct curved surfaces 170. The sub-reflector assembly 30 has a first longitudinally-extending member 31 and a second longitudinally-extending member 32 that opposibly face each other, each having a reflective surface 34. FIGS. 7, 10 (left panel). The two longitudinally-extending members 31 and 32 are positioned to create a sub-reflector volume 33 that sits between an optical light source 35 (an optionally thermally insulative and optically transparent tube 81) and at least part of a target area 36 beneath the optical reflector. FIG. 18. In an embodiment, the longitudinally-extending member reflective surfaces 34 are positioned at an off-vertical angle that is at or between about 10° and 45°. In an embodiment, the longitudinally-extending member reflective surfaces 34 are curved, optionally with a curvature defined by a plurality of complex elliptical surfaces. In an embodiment, a first end reflective surface 37 and second end reflective surface 38 connect the first and second longitudinally extending members 31 and 32 to form four sides of the sub-reflector volume 33 with an open top surface 39 and an open bottom surface 40. FIG. 10.

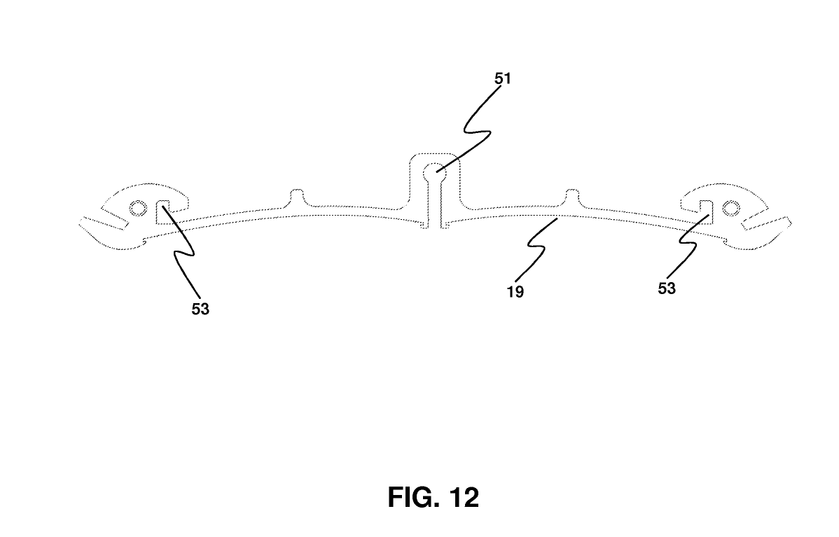

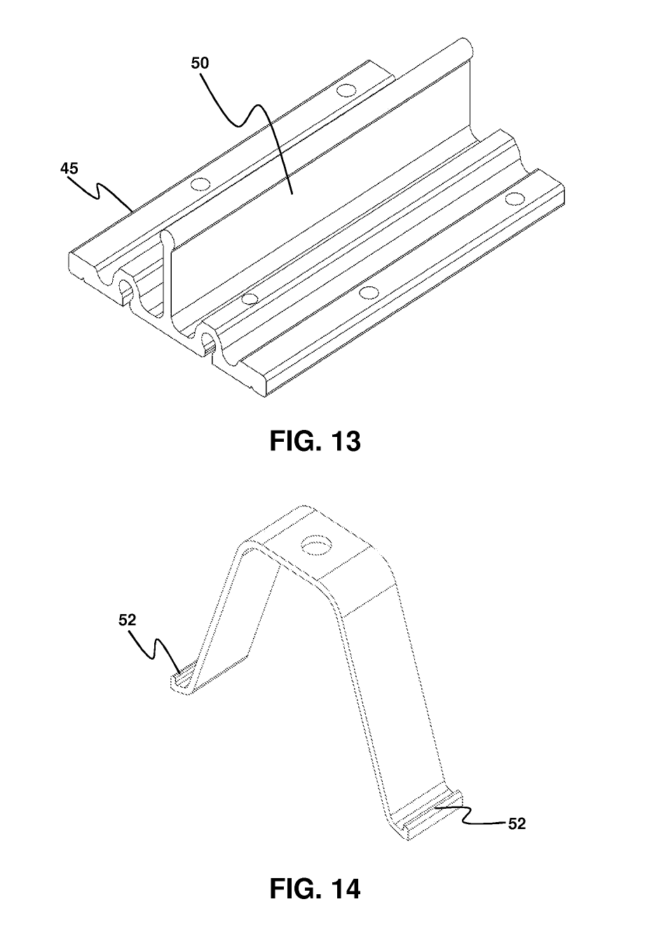

The reflector can have a first end bracket 41 and a second end bracket 43 connected to the first and second longitudinally-extending members 31 and 32 through a first edge 42 and second edge 44. FIG. 10. These brackets may allow for the attachment of mounting brackets 45 and 46 which connect the sub-reflector assembly 30 to the top interior facing surface 19. FIGS. 7, 10. Optionally, the mounting brackets 45 and 46 may be moveably connected to the top interior facing surface 19. In the embodiment shown, a tongue 50 and groove 51 connection may be used to make the moveable connection slideable. FIGS. 12-13.

The first and second longitudinally-extending members 31 and 32 may be rectangular shaped with side longitudinal lengths 20 that are less than the longitudinal lengths 47 of the first and second sides 14 and 15 of the central section 10. In an embodiment, the ratio of the longitudinal length 20 (FIG. 10) to the side longitudinal length 47 (FIG. 6) is less than 0.5. In an embodiment, there may be multiple sub-reflector assemblies in the optical reflector.

The optical reflector may have a top reflective surface 48 located between the top 11 of the central section 10 and the longitudinally-extending members 31 and 32. The top reflective surface 48 and side reflective surfaces 18 may be replaceable liners 21. FIG. 9. Optionally, the replaceable liners 21 may be composed of polished aluminum.

In an embodiment, an optically transparent material 70 may be connected to the bottom edges of the first and second sides 22 and 23. FIG. 9. This optically transparent material may comprise a low iron glass and/or an anti-reflective coating. The optically transparent material may transmit at least 85% of electromagnetic radiation in the visible spectrum from the interior volume 16 to the target area 36.

In an embodiment, the optical reflector has a longitudinally aligned light source 80 and a thermally insulative and optically transparent tube 81 that thermally isolates the light source (schematically illustrated in FIG. 18, inset). This tube may be quartz. This embodiment can further comprise a first and second end spacer 82 and 83 to physically separate the light source from the tube by a separation distance that is at or between 1 mm and 10 cm.

Referring to FIG. 6, the optical reflector may contain a first and second hanger assembly 100 and 101, which are connected to an outer facing surface 24 of the top 11 of the central section 10. The hanger assemblies are separated from each other by a hanger separation distance 102. The hanger assembly may be moveable, such as by a hanger tongue 52 and hanger groove 53 connection. FIGS. 12, 14. The hanger assembly may comprise a curved hanger bracket 103 having a central portion 104, a first and second end 105 and 106 that extend downward to connect to the top 11 by mounting ends 107. The top surface 109 of the hanger can have a fastener 108 for suspending the reflector. FIG. 10 (right panel).

In an embodiment the optical reflector has two end plates 110 and 111, which may have inner facing surfaces 112 that are reflective. FIG. 7.

The side reflective surfaces 18 and reflective surfaces of the longitudinally-extending members 34 may have curvatures defined by a plurality of complex elliptical shapes 120.

Also provided are optical reflectors that use low iron flat glass as the bottom surface of the reflector. The glass protects the crop from being damaged from an exploding bulb or bulbs that melt down. It also protects the highly polished aluminum liner from being damaged when plants are sprayed. It also increases safety for workers protecting them from direct contact with the bulbs. The use of low iron glass is desirable because it has a higher light transmittance than conventional glass, while preserving the functional benefit of protection from the optical light source.

In another embodiment, provided is an optical reflector having a sliding socket bracket, also referred herein as a a movable mounting bracket. The novel mounting bracket that is adjustable for any length optical light source, for any quantity of light sources that will fit, also allows for more efficient light source placement at the end of rows. The light source naturally casts light out the end, and this end-directed light is difficult to direct inside the reflector. When lights are in rows the wasted light is cast on to the next canopy except at the end of a row, with the exception of an optical reflector that is at the end of a row, where the light is cast on the floor or the wall and is wasted. The movable mounting brackets described herein facilitates adjustment of light source within the reflector housing by moving the light source away from the end of the row. This correspondingly increases the optical efficiency of the reflector by casting more of the light on the plant canopy.

Also provided herein are specially configured optical light sources that are positioned within a tube, such as a quartz tube. This facilitates an increase in light intensity provided to the plant canopy, allows cooling of the light source without spectrum shift by flowing air, including cooled air, over an exterior facing surface of the tube, and increases safety in case the light source melts down or explodes.

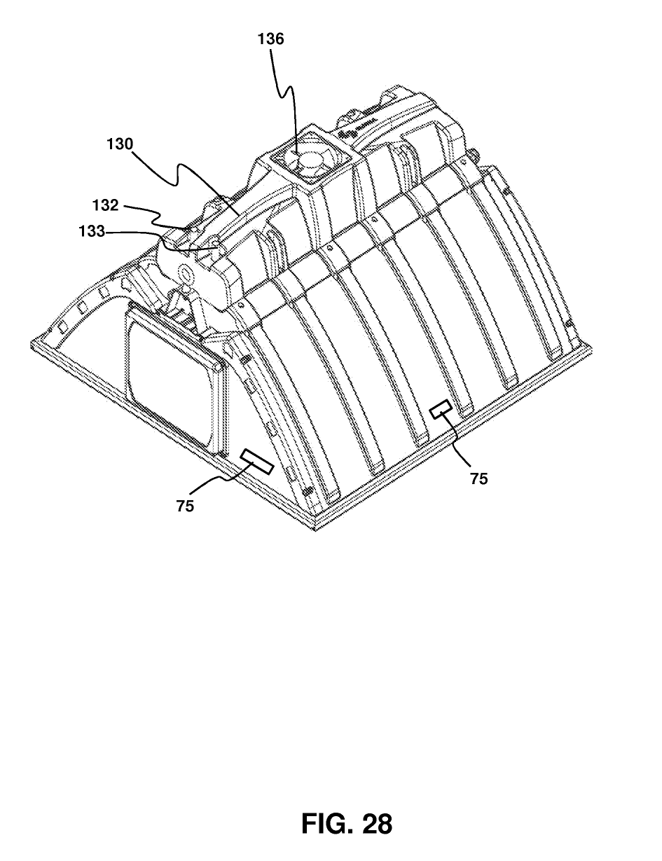

Optionally, any of the optical refelctors may further comprise one or more level indicators on the sides and/or end of the reflector so that during installation and during reflector adjustment a user can quickly determine if the reflector is level or not. If the reflector is not level, light distribution is uneven. Without a level indicator, it is challenging to determine whether the reflector is level or not. In an embodiment, the level indicator is a bubble level indicator. In an embodiment, there is a level indicator on each of the four surfaces that define the housing internal volume that receives the optical light source. Level indicator 75 is shown in FIG. 28 on an end surface and a front surface.

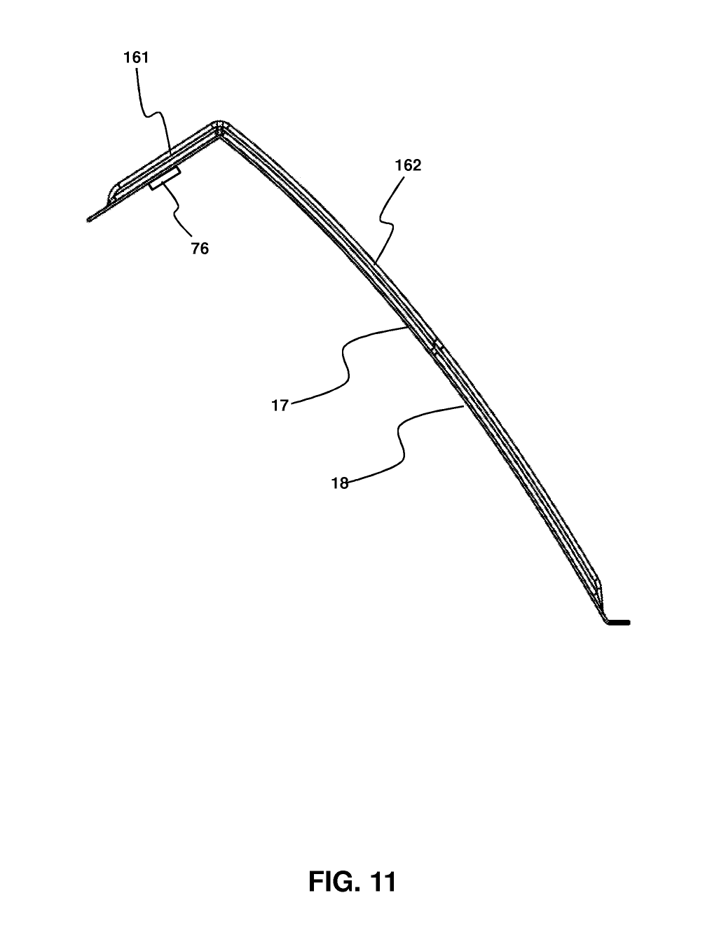

FIG. 11 illustrates the curvature of the central portion of the reflector housing, with reflective surface portion 17 and non-reflective surface 161. A light source 76, such as an LED, may be positioned on a non-reflective surface 161. In this manner, light may be provided even when the primary optical light source is not on, such as during a plant dark cycle. In an aspect, light 76 may be a green LED. In this manner, work may continue in the garden during the dark cycle, without a need for separate flashlights. Positioning such lights on non-reflective surface does not interfere with light transmission when the primary light source in the housing is on. In another embodiment, the light 161 may be provided on an outside perimeter of the reflector housing.

Also provided herein is an optical light source having an outer surface, the optical light source comprising a quartz tube that is separated from the outer surface by a separation distance, wherein an inner surface of the quartz tube and the outer surface of the optical light source define an insulative volume. This configuration is beneficial because the insulative volume increases an operating temperature of the optical light source during use compared to an equivalent optical light source without the quartz tube. This increase can occur even while the rest of the bulb is being activity cooled, such as by any of the cooling systems provided herein. The increase in operating temperature provides an at least 5% increase in light output compared to an equivalent optical light source without the quartz tube. In an aspect, the quartz tube is resistant to optical light source explosion or melting. The optical light source may be a high pressure sodium light source.

### EXAMPLE 2

### Air-Cooled Optical Reflector

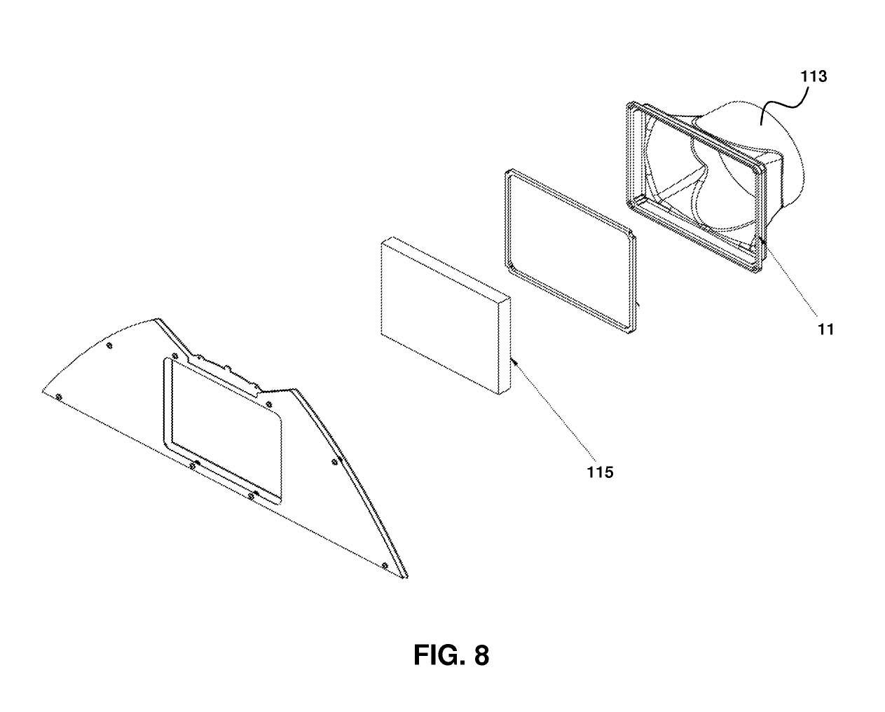

In embodiments where active air cooling is desired, the optical reflector has an inlet duct 113 for introducing air flow into the interior volume 16, and an outlet duct 114 for removing a flow of air from the interior volume 16. FIG. 7. The optical reflector may contain an air filter 115 connected to the inlet duct. FIG. 8.

### EXAMPLE 3

### Liquid-Cooled Optical Reflector

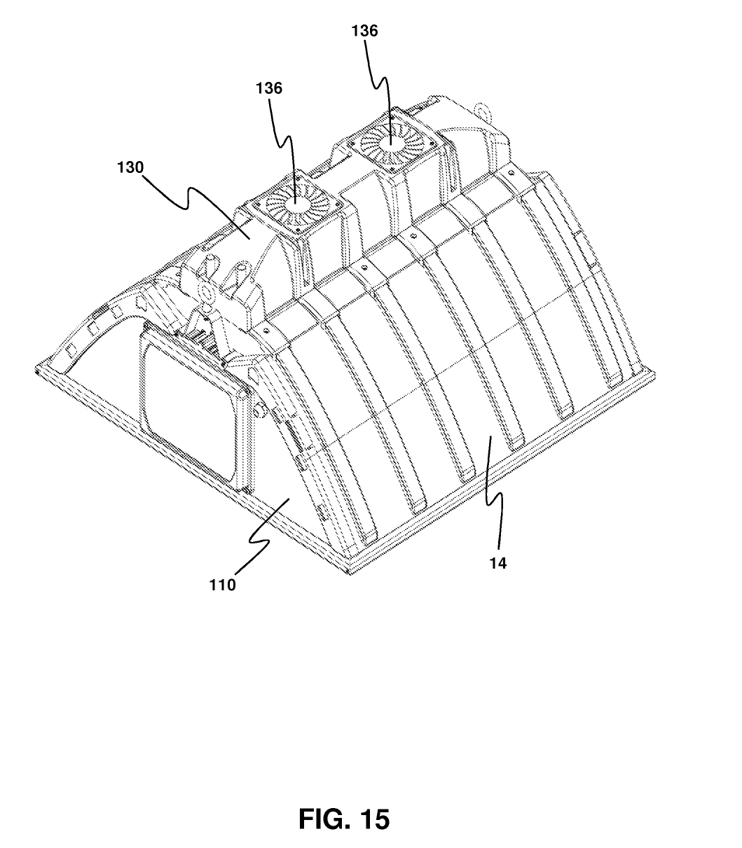

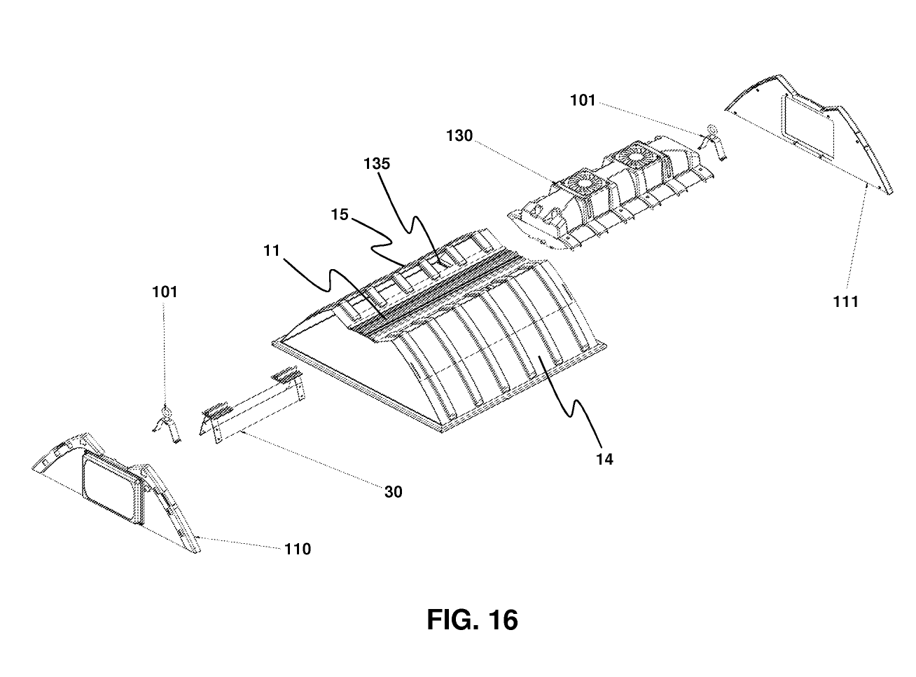

FIG. 15 is one example of a liquid-cooled optical reflector. The optical reflector has a heat exchanger assembly 130 that may connect to the top 11 of the central section 10 (FIG. 16). The heat exchanger assembly may comprise an air-to-water heat exchanger 131 having a water inlet port 132, a water outlet port 133, a thermal exchange portion 134 that connects the water inlet port 132 to the water outlet port 133, and an air port 135 that connects the heat exchanger assembly 130 with the interior volume 16. This allows air introduced from the interior volume 16 to be cooled by the air-to-water heat exchanger 131. FIGS. 15-17.

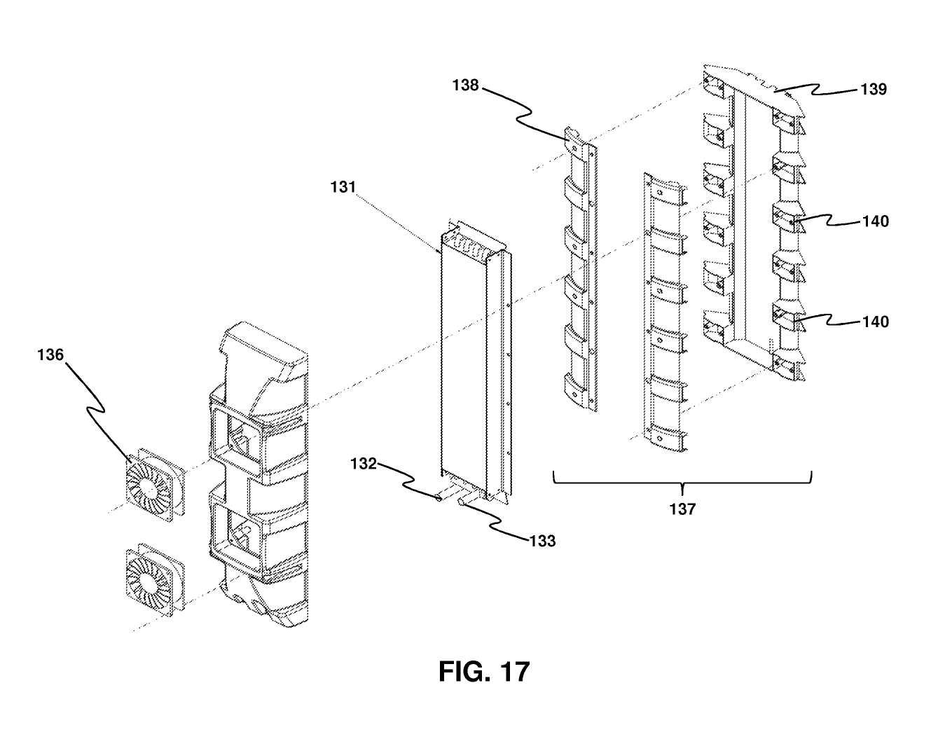

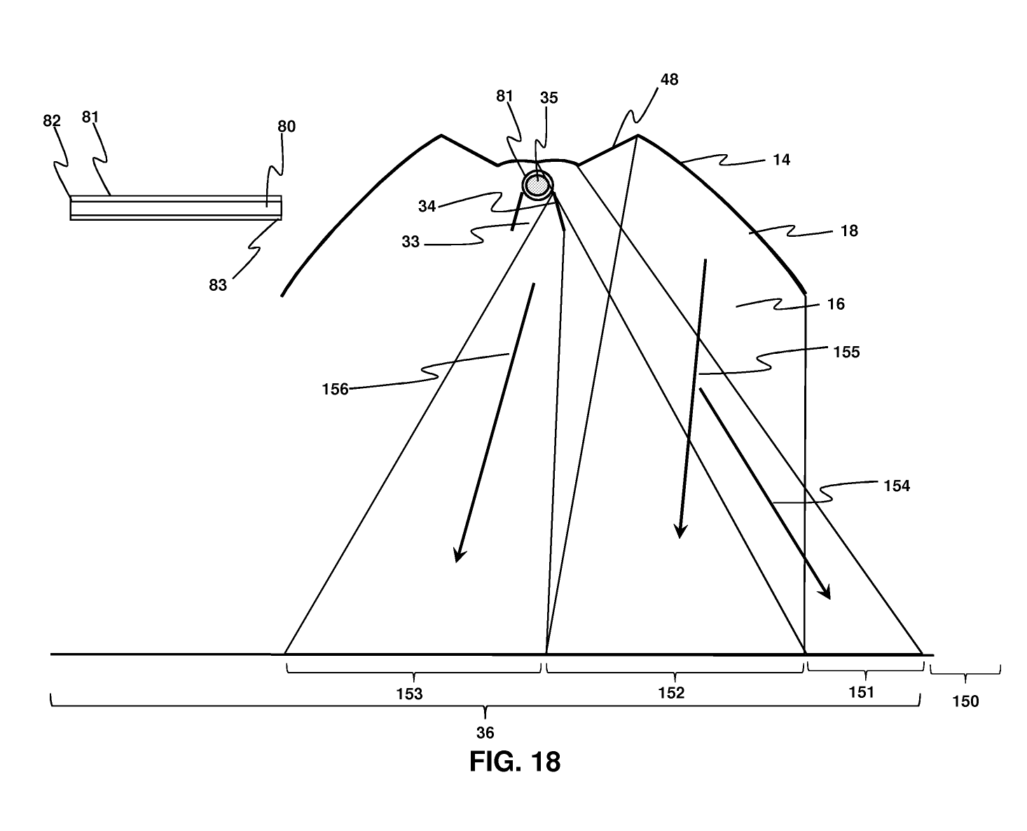

The optical reflector may have a fan 136 for forcing the air flow across the thermal exchange portion 134. In the exemplified embodiment, the optical reflector has two fans 136 positioned on top of the air-to-water heat exchanger 131. FIG. 17.

Referring to FIG. 17, the optical reflector may have a manifold 137 for supporting the air-to-water heat exchanger, the manifold having a manifold lid 138, a manifold pan 139, and a plurality of manifold passages 140 that fluidically connect with the air port 135 through the central portion of the optical reflector.

Referring to FIG. 28, another embodiment of a liquid-cooled optical reflector has a single fan 136 for forcing air flow across the thermal exchange portion 134. As desired, the cooled air may be introduced to a desired location to provide cooling capacity. For example, the cooled air may be introduced over an external surface of the reflector housing to help dissipate heat. Alternatively, the cooled air may be introduced within the housing. Alternatively, the cooled air may be used in another process associated with the grow application. Alternatively, the cooled air may be controllably introduced to a variety of locations, such as by use of flow controllers, flow valves and the like.

The reflector manifold may also serve as a drain pan for condensation removal when using water below dew point. A drain pan increases reflector safety in that if there is a leak the water drains into the pan. Similarly, if there is a leak above the reflector (in a multi level garden, for example) and water gets inside the housing, the water is directed into the pan. The pan has a primary and secondary drain. The primary is hooked up to a drain line or a small condensate pump that is fluidically connected to the reflector. If the reflector is drained by gravity, no pump is necessary. If the water must be forced against gravity, such as up to the ceiling before entering a drain pipe, a mini condensate pump may be used. The secondary drain is provided in case the primary drain is blocked or the condensate pump malfunctions. This secondary drain allows water to flow out of the pan just before it overflows, with the water draining out past the end of the reflector to ensure damage is avoided. This water drainage is noticeable to the user and provides an alert that the primary drain is blocked or that the pump motor is malfunctioning.

### EXAMPLE 4

### Vented Optical Reflector

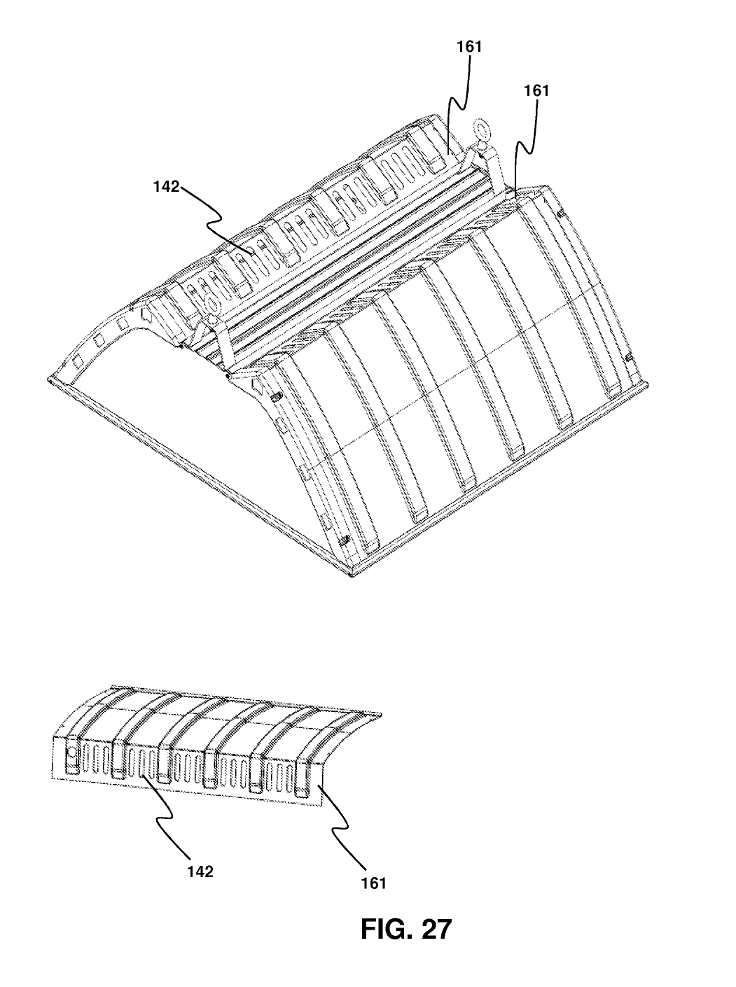

Referring to FIG. 27, the optical reflector may have a plurality of thermal vents 142 extending through the first side 14, second side 15, and/or top 11. In particular, the thermal vents extend through a portion of the side that does not have an optically reflective surface, such as in the portion of the side that is the upward angled interior region 161.

### EXAMPLE 5

### Illumination Characteristics

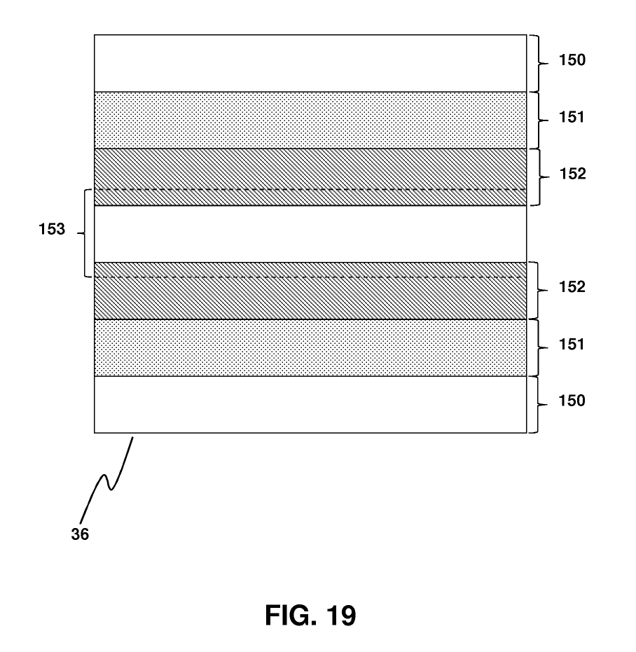

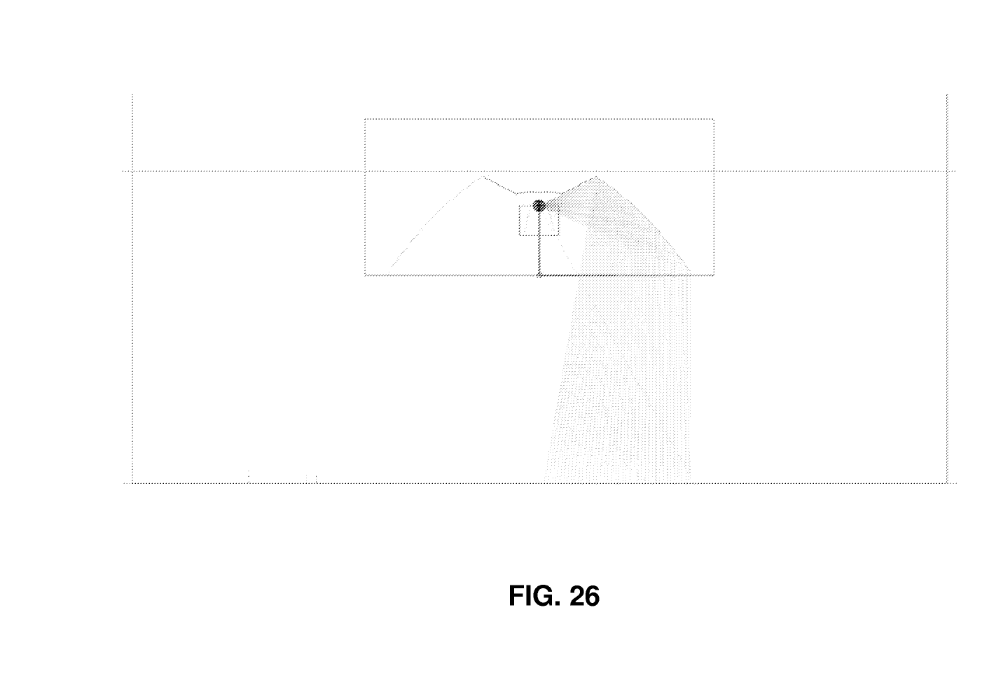

The specially configured reflective surfaces and their relative orientation with respect to a light source provides good illumination characteristics. Each reflective surface is configured to provide highly normal illumination to a specific region of a target area. This ensures that there is minimal canopy shading, particularly around outer edges of the target area. FIGS. 18 and 26-28 are ray tracing diagrams for one half of an optical reflector. The top surface reflector ensures light 154 is directed to an outer portion 151 of the target area. The side reflective surfaces provide highly normal incident light 155 to a middle region of the target area 152. The longitudinally-extending member reflective surfaces provide highly normal incident light 156 to an inner region 153 of the target area 36. As illustrated, no direct light rays escape to a non-target area outside the target area. FIG. 19 is a top view schematic illustration of the entire target area 36 of FIG. 19, and provides exemplary definitions of the non-target area 150, outer region 151, middle region 152, and inner region 153. The angle of light incidence (relative to horizontal) is greater than or equal to 45°, or greater than or equal to 55°, or greater than or equal to 60°, even for an outermost region 151 of the target area, such as the outermost 10%, outermost 5%, or outermost 1% of the target area.

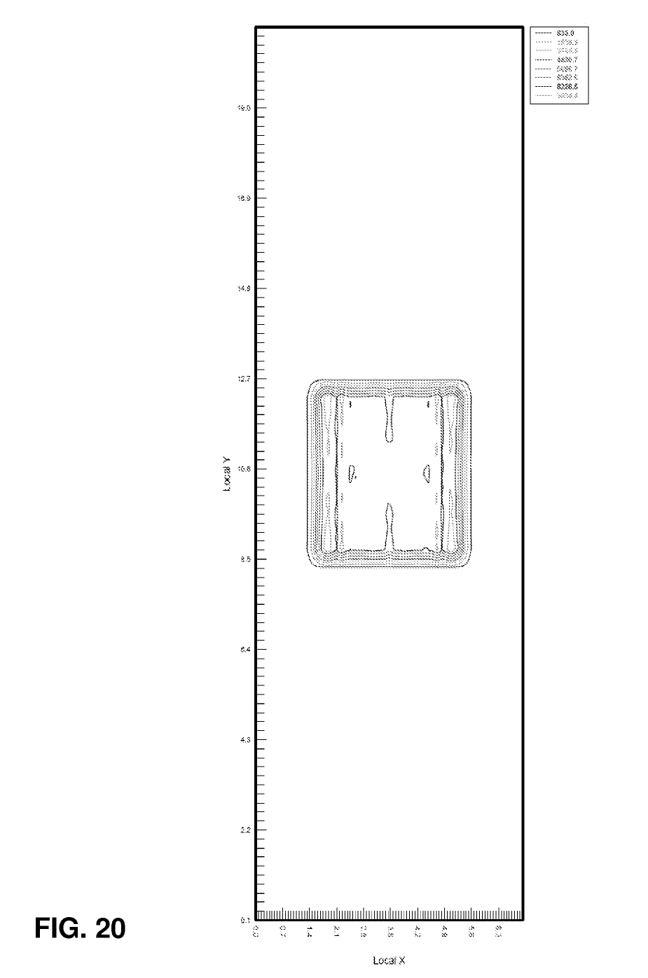

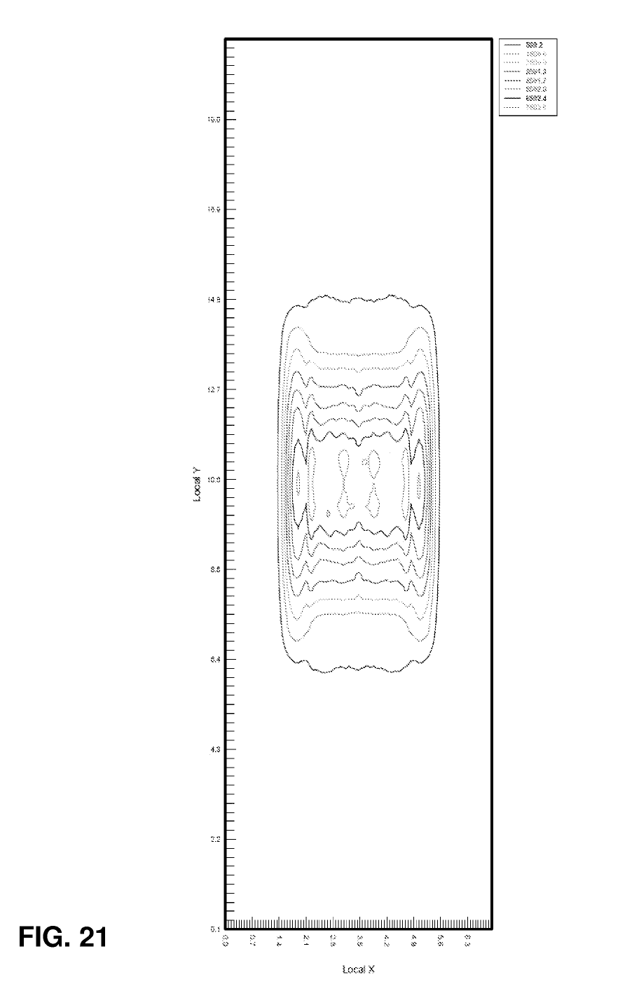

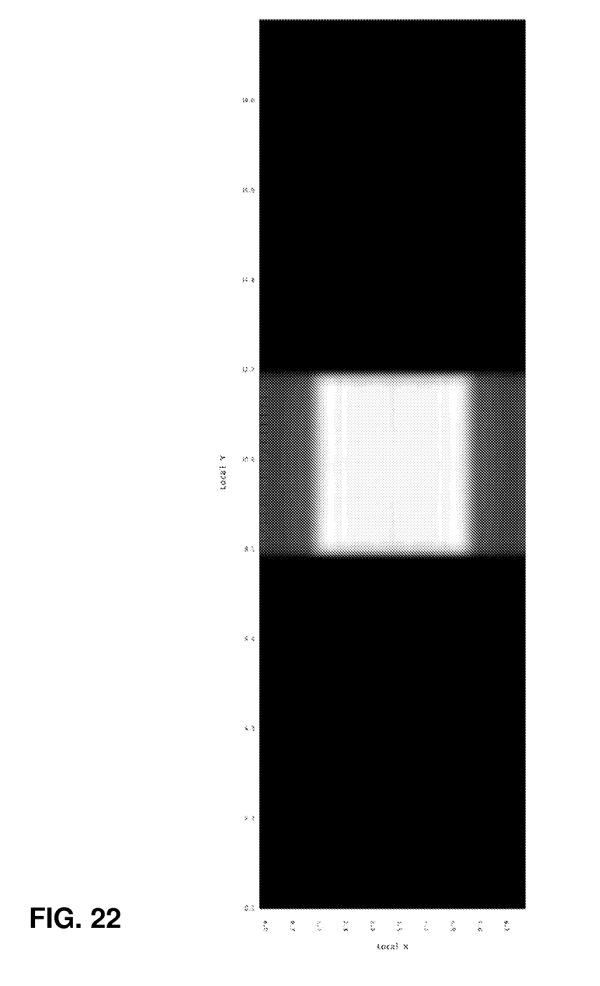

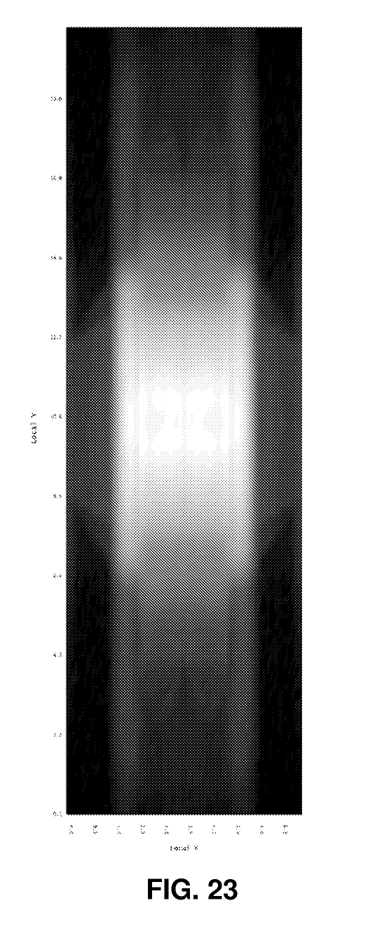

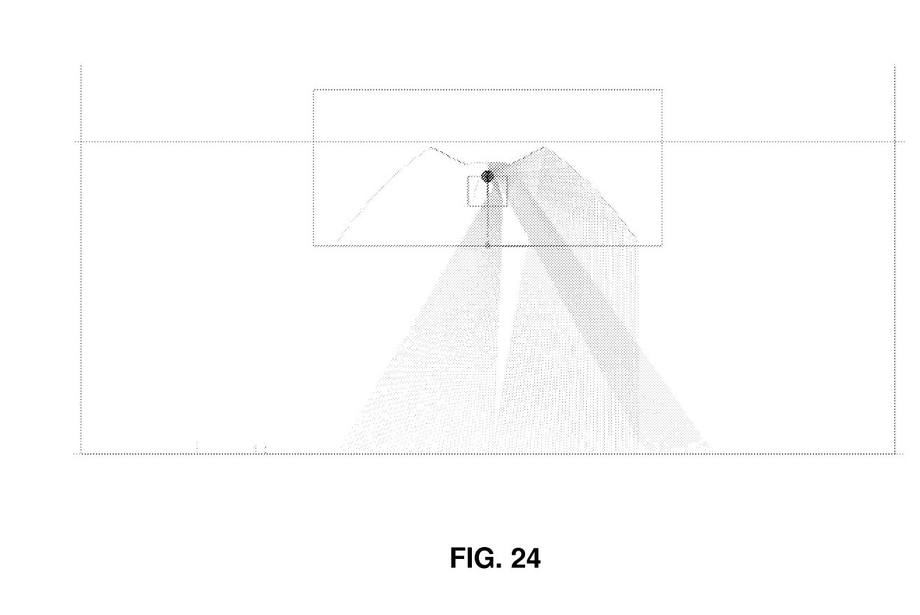

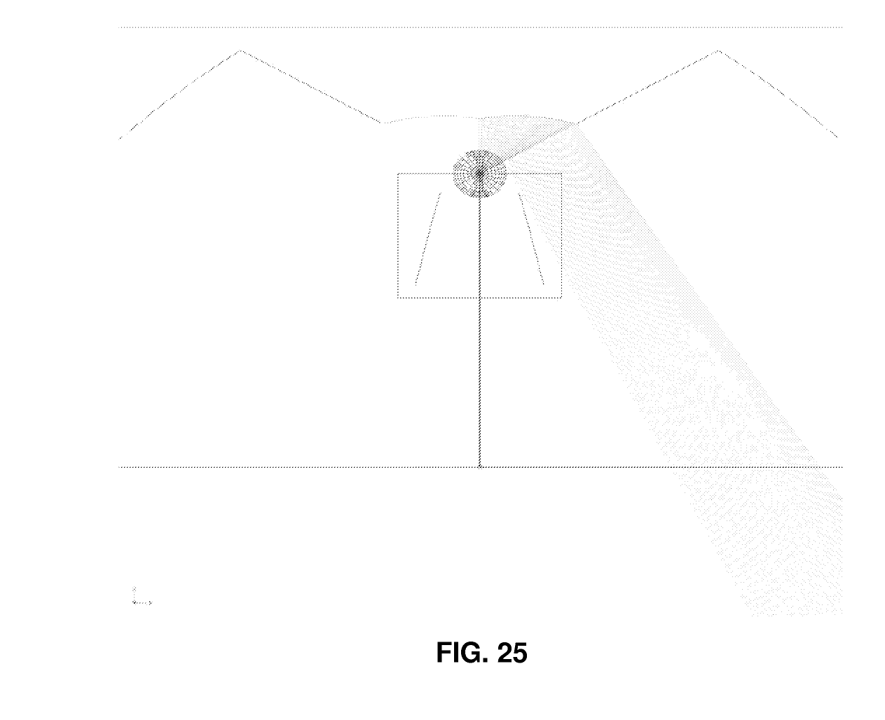

The improved illumination characteristics are further illustrated in FIGS. 20-26.

### Statements Regarding Incorpoiration by Reference and Variations

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods, and steps set forth in the present description. As will be obvious to one of skill in the art, methods and devices useful for the present methods can include a large number of optional composition and processing elements and steps.

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure.

Every formulation or combination of components described or exemplified herein can be used to practice the invention, unless otherwise stated.

Whenever a range is given in the specification, for example, a temperature range, an angle range, a light intensity range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1.-80. (canceled)

81. An optical reflector comprising:
a central section comprising a topwall and a sidewall that defines:
an interior volume having an interior facing surface at least a portion of which comprises a side reflective surface to reflect light to a target area beneath the optical reflector;
a sub-reflector assembly connected to said interior facing surface of said topwall and positioned within said interior volume, said sub-reflector assembly comprising:
a first and a second longitudinally-extending member arranged in an opposable configuration with respect to each other and longitudinally aligned with said topwall and said sidewall, each longitudinally-extending member comprising a reflective surface that opposibly face each other in an inward facing direction;
wherein said pair of longitudinally-extending members defines a sub-reflector volume positioned between an optical light source and at least a portion of a target area beneath the optical reflector to direct light generated from an optical light source to the target area.

82. The optical reflector of claim 81, wherein said topwall has a first top side and a second top side, further comprising;
a first side connected to and extending from said first top side;
a second side connected to and extending from said second top side, wherein said first side and said second side opposibly face each other and each of said first side and second side have an interior facing surface that comprises an optically reflective surface;
wherein each of said first and second longitudinally-extending members reflective surface:
is configured to provide substantially normal incident light over substantially all of said target area and prevent direct light leakage to a non-target area that is outside the target area during use of the optical reflector; and
are positioned at an off-vertical angle that is greater than or equal to 10° and less than or equal to 45°.

83. The optical reflector of claim 82, wherein each of said longitudinally-extending members reflective surfaces are curved.

84. The optical reflector of claim 82, further comprising:
a first end reflective surface connecting said first longitudinally-extending member reflective surface to said second longitudinally-extending member reflective surface at a first end; and
a second end reflective surface connecting said first longitudinally-extending member reflective surface to said second longitudinally-extending member reflective surface at a second end;
thereby forming four sides of said sub-reflector volume with an open top surface for heat transfer and an open bottom surface for light transmission toward a target area beneath said optical reflector.

85. The optical reflector of claim 82, wherein said sub-reflector assembly further comprises:
a first end bracket connected to a first edge of said first longitudinally-extending member and a first edge of said second longitudinally-extending member; and
a second bracket connected to a second edge of said first longitudinally-extending member and a second edge of said second longitudinally-extending member.

86. The optical reflector of claim 82, wherein said sub-reflector assembly further comprises a mounting bracket that operably connects said sub-reflector assembly to said top interior facing surface.

87. The optical reflector of claim 86, comprising a first mounting bracket connected to said first end bracket and a second mounting bracket connected to said second end bracket; wherein said mounting bracket is moveably connected to said top central section and the moveably connected is by a moveable connection comprising:
a tongue and groove connection to provide a slideable connection between said sub-reflector assembly and said top central section and said groove is positioned in or on an interior facing surface of said top central section and said tongue extends from a top surface of said mounting bracket.

88. The optical reflector of claim 87, wherein said longitudinally extending member reflective surface comprises silver-coated aluminum.

89. The optical reflector of claim 82, further comprising a top reflective surface positioned between said top central section and said pair of longitudinally-extending members for reflecting light from a direction that is toward said top central section to a target area beneath the optical reflector;
wherein said side reflective surfaces, said top reflective surface, or both said side reflective surfaces and top reflective surface comprises a replaceable liner formed of silver-coated aluminum.

90. The optical reflector of claim 82, further comprising an optically transparent material that connects a bottom edge of said first side to a bottom edge of said second side, wherein said optically transparent material comprises a low iron glass and/or an anti-reflective coating that transmits from said internal volume to said target area at least 85% of electromagnetic radiation in the visible spectrum.

91. The optical reflector of claim 81, further comprising:
a longitudinally aligned light source connected to said top central section;
a tube that is thermally insulative and optically transparent that thermally isolates said longitudinally aligned light source, wherein said longitudinally aligned light source is concentrically positioned relative to said tube;
a first and second end spacer to physically separate said longitudinally aligned light source from said tube by a separation distance, wherein said separation distance is selected from a range that is greater than or equal to 1 mm and less than or equal to 10 cm to form an insulated optical volume; and
a source of cooled air that flows over an outer surface of said tube.

92. The optical reflector of claim 91, wherein said tube comprises quartz.

93. The optical reflector of claim 81, further comprising a first and a second hanger assembly, wherein each of said hanger assembly is connected to an outer-facing surface of said top central section and separated from each other by a hanger separation distance; each of said hanger assembly is moveably connected to said top outer-facing surface; said hanger assembly comprising a curved hanger bracket having:
a central portion with a first end and a second end extending therefrom;
each of said first end and second end extending in a downward direction relative to said central portion and terminating in a mounting end that connects to said top; and
a fastener connected to a top surface of the hanger for suspending said optical reflector from an external surface or mount;
wherein the moveably connected is a moveable connection comprising a pair of slideable tongue and groove connection, wherein said tongue is at each of said first and second end of said curved hanger bracket, and said grooves are supported by or embedded in an outward facing surface of said top and configured to slideably receive said tongues.

94. The optical reflector of claim 81, further comprising:
a first end plate connected to a first edge of said topwall, a first edge of said first side and a first edge of said second side;
a second end plate connected to a second edge of said topwall, a second edge of said first side and a second edge of said second side; and
wherein each of said first and second end plates have an inner facing surface that is a reflective surface.

95. The optical reflector of claim 82, wherein:
each of said side reflective surfaces have a curvature defined by a plurality of complex elliptical shapes, wherein said plurality of complex elliptical shape side reflective surfaces are selected from a number that is greater than or equal to 3 and less than or equal to 25;
each of said longitudinally-extending member reflective surface have a curvature defined by a plurality of complex elliptical shapes, wherein said plurality of complex elliptical shape longitudinally-extending member reflective surfaces are selected from a number that is greater than or equal to 3 and less than or equal to 15; and
each individual of said plurality of complex elliptical shape are optically aligned with an individual sub-region of the target area.

96. The optical reflector of claim 82, further comprising:
a first end plate connected to a first edge of said topwall, a first edge of said first side and a first edge of said second side, said first end plate having an inlet duct for introducing a flow of air to said interior volume; and
a second end plate connected to a second edge of said topwall, a second edge of said first side and a second edge of said second side, said second end plate having an outlet duct for removing a flow of air from said interior volume.

97. The optical reflector of claim 96, further comprising:
a longitudinally aligned light source connected to said top central section;
a tube that is thermally insulative and optically transparent that thermally isolates said longitudinally aligned light source, wherein said longitudinally aligned light source is substantially concentrically positioned relative to said tube; and
an insulated optical volume between an outer surface of the longitudinally aligned light source and an inner surface of the tube;
wherein flow of air directed over an outer surface of said tube provides thermal cooling of said interior volume without substantially changing temperature in the insulated optical volume.

98. The optical reflector of claim 82, further comprising a heat exchanger assembly thermally connected to said top central section, said heat exchanger assembly comprises an air-to-water heat exchanger having:
a water inlet port for the introduction of cool water to the air-to-water heat exchanger;
a water outlet port for removing heated water from the air-to-water heat exchanger;
a thermal exchange portion that fluidically connects said water inlet port and said water outlet port configured to cool a flow of air across said thermal exchange portion;
an air port fluidically connecting said heat exchanger assembly with said interior volume, wherein air introduced from said interior volume is cooled by said air-to-water heat exchanger; and
a fan for forcing said flow of air across said thermal exchange portion.

99. The optical reflector of claim 98, wherein during use said cooled air is introduced to a surrounding environment in which said optical reflector is located to provide thermal cooling of the surrounding environment, and the surrounding environment is a room in which plants are growing.

100. The optical reflector of claim 98, further comprising a manifold connected to said top central section for supporting said air-to-water heat exchanger and a plurality of passages through said top central section, said manifold comprising:
a manifold lid; and
a manifold pan having a concave shaped surface for collecting water condensate or drips and a plurality of manifold passages for receiving a flow of air from said interior volume;
wherein said manifold passages are spatially aligned with said plurality of passages through said top central section.

101. The optical reflector of claim 82, further comprising a plurality of thermal vents extending through said first side, said second side, and/or said top, for movement of air between said interior volume and a surrounding environment.

102. The optical reflector of claim 81, further comprising an optical light source that is a double-ended high-intensity discharge light.

103. A method of growing a plant comprising the steps of:
positioning an optical reflector in a room, wherein said optical reflector comprises:
a central section comprising a topwall and a sidewall that defines:
an interior volume having an interior facing surface at least a portion of which comprises a side reflective surface to reflect light to a target area beneath the optical reflector;
a sub-reflector assembly connected to said interior facing surface of said topwall and positioned within said interior volume, said sub-reflector assembly comprising:
a first and a second longitudinally-extending member arranged in an opposable configuration with respect to each other and longitudinally aligned with said topwall and said sidewall, each longitudinally-extending member comprising a reflective surface that opposibly face each other in an inward facing direction;
wherein said pair of longitudinally-extending members defines a sub-reflector volume positioned between an optical light source and at least a
portion of a target area beneath the optical reflector to direct light generated from an optical light source to the target area;
providing a plant in a target area that is located beneath said optical reflector;
powering an optical light source operably connected to said optical reflector;
illuminating said plants in said target area with said powered optical light source, thereby growing said plant;
wherein said target area greater than or equal to 10 ft² and less than or equal to 75 ft² and is positioned at a separation distance from said optical light source, wherein said separation distance is greater than or equal to 1 foot and less than or equal to 10 feet; and
said illuminating step provides improved illumination characteristics comprising a substantially normal angle of light incidence over substantially the entire target area.

104. The method of claim 103, further comprising the step of cooling the optical reflector or the environment surrounding the optical reflector by one or more of air cooling or liquid cooling, wherein the cooling is at least 50% more energy efficient than power requirements for a corresponding conventional grow environment.

105. An optical reflector comprising:
a top comprising a top reflective surface;
a first side connected to said top, said first side having a first side reflective surface;
a second side connected to said top, said second side having a second side reflective surface, wherein said top, said first side and said second side form an interior volume in which an optical light source may be positioned;
a sub-reflector assembly connected to said top and positioned in said interior volume, said sub-reflector assembly comprising a pair of aligned sub-reflector reflective surfaces to form a sub-reflector volume through which downward-directed light from an optical source traverses to a target area beneath the optical reflector;
wherein each of said reflective surfaces is configured to provide a substantially normal direction of light illumination over substantially the entire target area positioned beneath said optical reflector and to prevent illumination of a non-target area that is outside said target area.
